(19) United States
(12) Patent Application Publication
(10) Pub. No.: US 2026/0122544 A1
(43) Pub. Date: Apr. 30, 2026

(54) HANDOVER WITH LOCATION STATE INFORMATION

(71) Applicant: Qualcomm Incorporated, San Diego, CA (US)

(72) Inventors: Chiranjib SAHA, Lakeside, CA (US); Ayan SENGUPTA, San Diego, CA (US); Alberto RICO ALVARINO, San Diego, CA (US)

(21) Appl. No.: 18/931,975

(22) Filed: Oct. 30, 2024

(51) Int. Cl. H04W 36/08; H04W 36/00; H04W 36/32

(52) U.S. Cl. CPC H04W 36/083; H04W 36/0077; H04W 36/32

(57) ABSTRACT

Various aspects of the present disclosure generally relate to wireless communication. In some aspects, a first network node may transmit, to a second network node, a handover request message indicating a handover request for a user equipment (UE), wherein the second network node is configured to support a non-terrestrial network (NTN) cell, and wherein the handover request message includes first information indicative of a location resolution operational state of the UE. The first network node may receive, from the second network node, a handover acknowledgment message that includes second information indicating whether the handover request is accepted, wherein the second information is associated with the location resolution operational state. Numerous other aspects are described.

### FIELD OF THE DISCLOSURE

Aspects of the present disclosure generally relate to wireless communication and specifically relate to techniques, apparatuses, and methods associated with a handover with location state information.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a first network node for wireless communication. The first network node may include one or more memories and one or more processors coupled to the one or more memories. The one or more processors may be configured to cause the first network node to transmit, to a second network node, a handover request message indicating a handover request for a user equipment (UE), wherein the second network node is configured to support a non-terrestrial network (NTN) cell, and wherein the handover request message includes first information indicative of a location resolution operational state of the UE. The one or more processors may be configured to cause the first network node to receive, from the second network node, a handover acknowledgment message that includes second information indicating whether the handover request is accepted, wherein the second information is associated with the location resolution operational state.

Some aspects described herein relate to a first network node for wireless communication. The first network node may include one or more memories and one or more processors coupled to the one or more memories. The one or more processors may be configured to cause the first network node to receive, from a second network node, a handover request message indicating a handover request for a UE, wherein the first network node is configured to support an NTN cell, and wherein the handover request message includes first information indicative of a location resolution operational state of the UE. The one or more processors may be configured to cause the first network node to transmit, to the second network node, a handover acknowledgment message that includes second information indicating whether the handover request is accepted, wherein the second information is associated with the location resolution operational state.

Some aspects described herein relate to a UE for wireless communication. The UE may include one or more memories and one or more processors coupled to the one or more memories. The one or more processors may be configured to cause the UE to receive, from a first network node, configuration information that is configured to enable the UE to establish a connection with a second network node, wherein the UE is configured to operate in a location resolution operational state, and wherein the configuration information is associated with the location resolution operational state. The one or more processors may be configured to cause the UE to transmit, to the second network node, a message for establishing the connection to an NTN cell supported by the second network node, in accordance with the configuration information.

Some aspects described herein relate to a method of wireless communication performed by a first network node. The method may include transmitting, to a second network node, a handover request message indicating a handover request for a UE, wherein the second network node is configured to support an NTN cell, and wherein the handover request message includes first information indicative of a location resolution operational state of the UE. The method may include receiving, from the second network node, a handover acknowledgment message that includes second information indicating whether the handover request is accepted, wherein the second information is associated with the location resolution operational state.

Some aspects described herein relate to a method of wireless communication performed by a first network node. The method may include receiving, from a second network node, a handover request message indicating a handover request for a UE, wherein the first network node is configured to support an NTN cell, and wherein the handover request message includes first information indicative of a location resolution operational state of the UE. The method may include transmitting, to the second network node, a handover acknowledgment message that includes second information indicating whether the handover request is accepted, wherein the second information is associated with the location resolution operational state.

Some aspects described herein relate to a method of wireless communication performed by a UE. The method may include receiving, from a first network node, configuration information that is configured to enable the UE to establish a connection with a second network node, wherein the UE is configured to operate in a location resolution operational state, and wherein the configuration information is associated with the location resolution operational state. The method may include transmitting, to the second network node, a message for establishing the connection to an NTN cell supported by the second network node, in accordance with the configuration information.

Some aspects described herein relate to a non-transitory computer-readable medium that stores a set of instructions for wireless communication by a first network node. The set of instructions, when executed by one or more processors of the first network node, may cause the first network node to transmit, to a second network node, a handover request message indicating a handover request for a UE, wherein the second network node is configured to support an NTN cell, and wherein the handover request message includes first information indicative of a location resolution operational state of the UE. The set of instructions, when executed by one or more processors of the first network node, may cause the first network node to receive, from the second network node, a handover acknowledgment message that includes second information indicating whether the handover request is accepted, wherein the second information is associated with the location resolution operational state.

Some aspects described herein relate to a non-transitory computer-readable medium that stores a set of instructions for wireless communication by a first network node. The set of instructions, when executed by one or more processors of the first network node, may cause the first network node to receive, from a second network node, a handover request message indicating a handover request for a UE, wherein the first network node is configured to support an NTN cell, and wherein the handover request message includes first information indicative of a location resolution operational state of the UE. The set of instructions, when executed by one or more processors of the first network node, may cause the first network node to transmit, to the second network node, a handover acknowledgment message that includes second information indicating whether the handover request is accepted, wherein the second information is associated with the location resolution operational state.

Some aspects described herein relate to a non-transitory computer-readable medium that stores a set of instructions for wireless communication by a UE. The set of instructions, when executed by one or more processors of the UE, may cause the UE to receive, from a first network node, configuration information that is configured to enable the UE to establish a connection with a second network node, wherein the UE is configured to operate in a location resolution operational state, and wherein the configuration information is associated with the location resolution operational state. The set of instructions, when executed by one or more processors of the UE, may cause the UE to transmit, to the second network node, a message for establishing the connection to an NTN cell supported by the second network node, in accordance with the configuration information.

Some aspects described herein relate to a first apparatus for wireless communication. The first apparatus may include means for transmitting, to a second apparatus, a handover request message indicating a handover request for a UE, wherein the second apparatus is configured to support an NTN cell, and wherein the handover request message includes first information indicative of a location resolution operational state of the UE. The first apparatus may include means for receiving, from the second apparatus, a handover acknowledgment message that includes second information indicating whether the handover request is accepted, wherein the second information is associated with the location resolution operational state.

Some aspects described herein relate to a first apparatus for wireless communication. The first apparatus may include means for receiving, from a second apparatus, a handover request message indicating a handover request for a UE, wherein the first apparatus is configured to support an NTN cell, and wherein the handover request message includes first information indicative of a location resolution operational state of the UE. The first apparatus may include means for transmitting, to the second apparatus, a handover acknowledgment message that includes second information indicating whether the handover request is accepted, wherein the second information is associated with the location resolution operational state.

Some aspects described herein relate to an apparatus for wireless communication. The apparatus may include means for receiving, from a first network node, configuration information that is configured to enable the apparatus to establish a connection with a second network node, wherein the apparatus is configured to operate in a location resolution operational state, and wherein the configuration information is associated with the location resolution operational state. The apparatus may include means for transmitting, to the second network node, a message for establishing the connection to an NTN cell supported by the second network node, in accordance with the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a regenerative satellite deployment and an example of a transparent satellite deployment in a non-terrestrial network.

FIG. 4 is a diagram illustrating an example of handover procedure, in accordance with the present disclosure.

FIG. 5 is a diagram of an example associated with a handover with location state information, in accordance with the present disclosure.

FIG. 6 is a diagram illustrating an example process performed, for example, at a first network node or an apparatus of a first network node, in accordance with the present disclosure.

FIG. 7 is a diagram illustrating an example process performed, for example, at a first network node or an apparatus of a first network node, in accordance with the present disclosure.

FIG. 8 is a diagram illustrating an example process performed, for example, at a user equipment (UE) or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A handover operation in a wireless communication network is an operation that facilitates the seamless transition of an ongoing session for a user equipment (UE) from one cell or network node to another, ensuring uninterrupted service as the UE moves through different geographic areas. For example, the UE may perform a handover process to change a communication connection from a source network node to a target network node. During the handover operation, information (e.g., context information) for the UE may be provided from the source network node to the target network node to enable the target network node to establish a connection with the UE. The handover operation enables the UE to maintain active communication sessions in mobility scenarios (e.g., while the UE is moving) and/or in scenarios where a quality of a communication link with the source network node becomes poor. A handover operation may be performed or initiated based on various parameters, such as signal strength, quality of service, and/or the UE location relative to different network nodes. The process involves coordinating between the source network node and the target network node to manage resources and maintain optimal network performance.

In some examples, the wireless communication network may include one or more non-terrestrial network (NTN) deployments in which a non-terrestrial wireless communication device may include a network node (referred to herein as a “non-terrestrial network node”) and/or a relay station (referred to herein, interchangeably, as a “non-terrestrial relay station”). As used herein, an NTN may refer to a network for which access is facilitated by a non-terrestrial network node and/or a non-terrestrial relay station. The wireless communication network may include any number of non-terrestrial wireless communication devices. A non-terrestrial wireless communication device may include a satellite and/or a high-altitude platform (HAP). A HAP may include a balloon, a dirigible, an airplane, and/or an unmanned aerial vehicle. A non-terrestrial wireless communication device may be part of an NTN that is separate from the wireless communication network. Alternatively, an NTN may be part of the wireless communication network. Satellites may communicate directly and/or indirectly with other entities in the wireless communication network using satellite communication. The other entities may include UEs, other satellites in the one or more NTN deployments, other types of network nodes (e.g., stationary or ground-based network nodes), relay stations, and/or one or more components and/or devices included in a core network of the wireless communication network.

NTNs offer connectivity solutions for varied environments and scenarios, such as remote regions, emergency or disaster situations, military operations, and other areas where terrestrial networks may not reach or be efficient. NTNs often rely on satellite systems and leverage global navigation satellite system (GNSS) data for accurate UE positioning or location resolution, which enables devices operating in the NTN to maintain synchronization with the satellite. This is beneficial for communications associated with the NTN due to significant timing and frequency offsets encountered in signal propagation over large distances associated with communication links in an NTN.

However, a dependency on location resolution data (e.g., GNSS data) for a handover operation may impose challenges depending on the location resolution operational state of the UE. In some examples, the location resolution operational state of the UE may indicate whether the UE is currently capable of accessing location resolution data. For example, when the UE is operating in a location resolution operational state in which the UE does not have access to location resolution data (e.g., due to the UE not supporting a GNSS capability or when the UE is temporarily operating without access to GNSS for one or more reasons, such as power saving), the handover operation from a source network node to a target network node may be hindered or degraded by the absence of precise location and timing information for the UE. This leads to complications in configuring random access resources and/or compensating timing and frequency adjustments during the handover operation. For example, the target network node may assume that the UE has access to location resolution data during the handover operation and/or may not receive location resolution data (e.g., indicating the location or position of the UE) as part of the handover operation. This may degrade performance of the handover operation, such as for scenarios in which there are large timing and/or frequency offsets or adjustments for a communication link (e.g., NTN deployments, high-mobility scenarios (e.g., high-speed train scenarios), or other scenarios).

Moreover, potential misconfigurations during handover may cause the target network node to treat a UE as having access to location resolution data, leading to potential handover failures (e.g., due to timing misalignments and/or frequency misalignments caused by the lack of location resolution data at the UE). Such misalignments between the UE's location resolution operational state and the expectation of the target network node can result in inefficiencies and disruptions in service continuity during handovers.

Various aspects relate generally to the enhancement of handover procedures for UEs operating without an active connection with a GNSS. Some aspects more specifically relate to a source network node transmitting, and a target network node receiving, a handover request that includes information indicative of a location resolution operational state of a UE. The location resolution operational state of the UE may indicate whether the UE has access to a GNSS or location resolution data. The target network node may transmit, and the source network node may receive, a handover acknowledgment that indicates whether a handover for the UE is accepted or rejected, where the acceptance or rejection is based on, or otherwise associated with, the location resolution operational state of the UE.

In some aspects, such as when the target network node (e.g., that is configured to support an NTN cell) accepts the handover for the UE, the handover acknowledgment may indicate handover information for the UE. The handover information may include a random access configuration, timing adjustment information, frequency adjustment information, and/or other information to facilitate the UE establishing a connection with the target network node. The handover information may be based on, or otherwise associated with, the location resolution operational state of the UE. For example, the target network node may identify or determine the handover information based on the location resolution operational state of the UE. In such examples, the source network node may transmit (e.g., forward), and the UE may receive, the handover information (such as in configuration information indicating that the UE is to initiate the handover operation with the target network node). The UE and the target network node may perform the handover operation (e.g., based on the handover information). For example, the UE may transmit, and the target network node may receive, a communication (e.g., in accordance with the handover information) to initiate a random access procedure for establishing a connection with the target network node.

In some other examples, the handover acknowledgment may indicate that the handover for the UE is rejected by the target network node. For example, the UE may be operating in a location resolution operational state in which the UE does not have access to a GNSS or location resolution data. The target network node may not support communicating with, or establishing a connection with, UEs without access to a GNSS or location resolution data. Therefore, the target network node may transmit, and the source network node may receive, an indication that the handover request is rejected for the UE.

Particular aspects of the subject matter described in this disclosure can be implemented to realize one or more of the following potential advantages. In some examples, the described techniques can be used to enable proper configuration and/or handling of communication parameters for managing a handover operation in accordance with a location resolution operational state of the UE. For example, by the source network node indicating the location resolution operational state in the handover request, the target network node may make improved determinations as to whether to accept or reject the handover request. For example, if the target network node does not support communicating with, or establishing a connection with, UEs operating in the indicated location resolution operational state, then the target network node may reject the handover request. This may reduce the likelihood of failed handover operations that may otherwise be caused by the UE attempting to establish a connection with the target network node that does not support the current location resolution operational state of the UE.

Additionally, by the source network node indicating the location resolution operational state in the handover request, the target network node may indicate handover information for the UE that is based on, or otherwise associated with, the location resolution operational state. This may improve the performance of the handover operation and/or improve the likelihood of a successful handover operation because the UE may perform the handover operation (e.g., may transmit or receive one or more random access messages) using the handover information that is based on (e.g., specific to or tailored to) the current location resolution operational state of the UE. For example, the handover information may include random access configuration information, timing adjustment information, and/or frequency adjustment information, among other examples, that can be used by the UE to improve the likelihood of a successful handover operation while operating in the location resolution operational state.

For example, the handover information may include a random access configuration associated with the location resolution operational state, enabling the UE to execute a random access operation without an active GNSS connection in some cases. This allows the target network node to pre-compensate for time and frequency variances during the random access operation based on the location resolution operational state, which can improve the likelihood of successful synchronization with the target network node during the handover operation. In some examples, the handover information may be based on accumulated timing and frequency adjustments or an estimated UE location, further improving pre-compensation calculations and/or further improving the likelihood of a successful handover operation by improving the synchronization accuracy.

As a result, potential misconfigurations and resultant handover failures, which could occur if the UE were incorrectly presumed to have GNSS functionality by the target network node, may be mitigated. By the source network node and the target network node being aware of the location resolution operational state of the UE during handover preparation, the described techniques can conserve network resources and/or processing resources by avoiding unnecessary handover attempts. Additionally, the described techniques can improve the likelihood of an uninterrupted network connection for the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

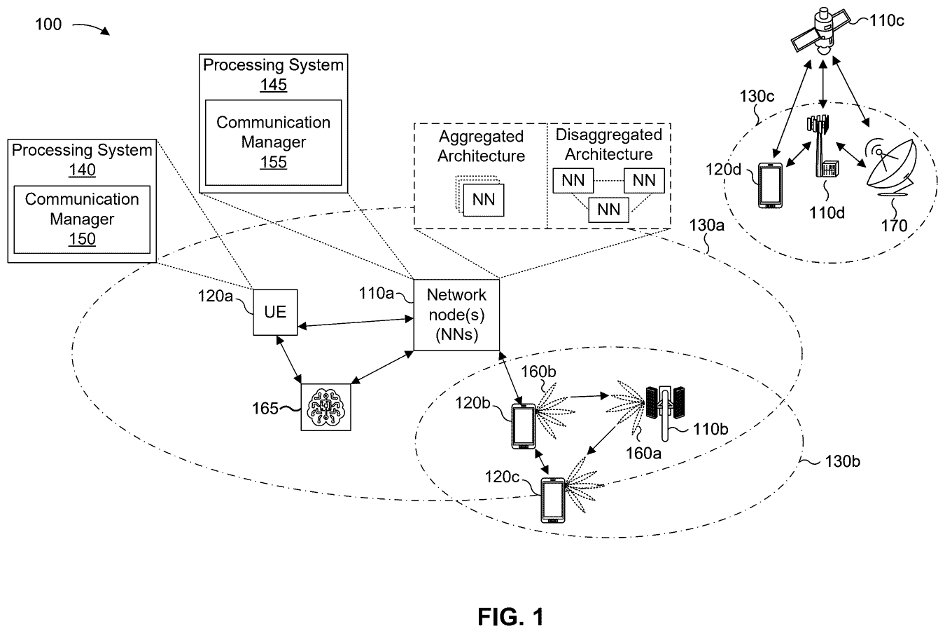

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, a network node 110c, and a network node 110d. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

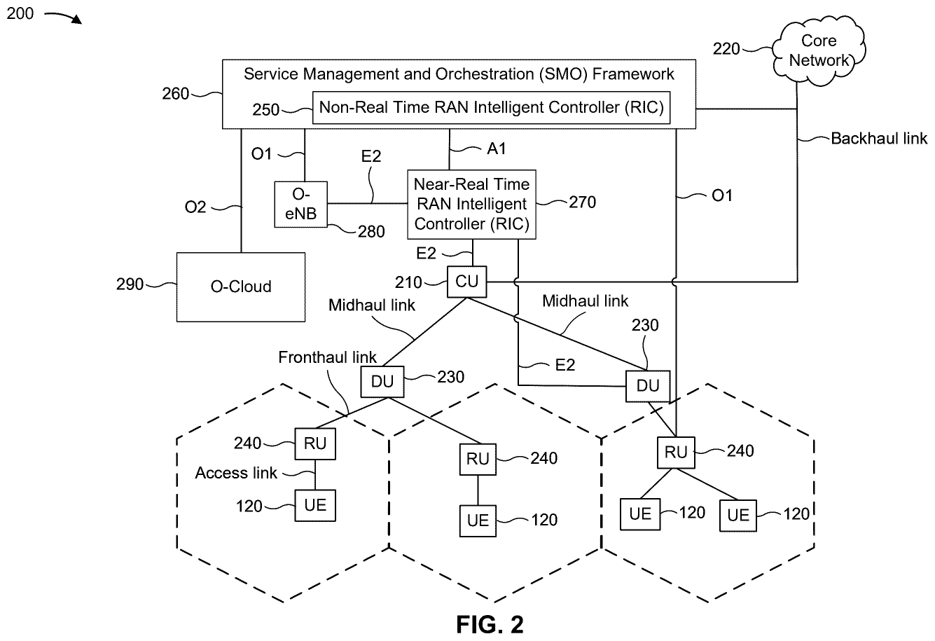

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

As indicated above, a network node 110 may be a terrestrial network node 110 (for example, a terrestrial base station or entity of a disaggregated base station) or an NTN network node 110. In the example shown in FIG. 1, the network node 110c may be an NTN network node 110 and the cell 130c may be an NTN cell. For example, the wireless communication network 100 may include one or more NTN deployments including an NTN network node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120 (for example, the UE 120d), other NTN network nodes 110 in the one or more NTN deployments, other types of network nodes 110 (for example, stationary, terrestrial, and/or ground-based network nodes, such as the network node 110d), relay stations, and/or one or more components and/or devices included in or coupled with a core network of the wireless communication network 100. For example, an NTN network node 110 may communicate with a UE 120 via a service link (for example, where the service link includes an access link). Additionally or alternatively, an NTN network node 110 may communicate with a gateway 170 (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). In some examples, an NTN deployment may be transparent (for example, where the NTN network node 110 operates in a similar manner as a repeater or relay and/or where an access link does not terminate at the NTN network node 110). In some other examples, an NTN deployment may be regenerative. For example, an access link may terminate at the NTN network node 110, and the NTN network node 110 may regenerate a signal (such as by performing signal processing or enhancement, which may include error correction, modulation or demodulation, or amplification).

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a GNSS device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the network node 110 may include a communication manager 155. As described in more detail elsewhere herein, the communication manager 155 of a first network node may transmit, to a second network node, a handover request message indicating a handover request for a UE, wherein the second network node is configured to support an NTN cell (e.g., the cell 130c), and wherein the handover request message includes first information indicative of a location resolution operational state of the UE; and receive, from the second network node, a handover acknowledgment message that includes second information indicating whether the handover request is accepted, wherein the second information is associated with the location resolution operational state. As described in more detail elsewhere herein, the communication manager 155 of a first network node 110 may receive, from a second network node, a handover request message indicating a handover request for a UE, wherein the first network node 110 is configured to support an NTN cell (e.g., the cell 130c), and wherein the handover request message includes first information indicative of a location resolution operational state of the UE; and transmit, to the second network node, a handover acknowledgment message that includes second information indicating whether the handover request is accepted, wherein the second information is associated with the location resolution operational state. Additionally, or alternatively, the communication manager 155 may perform one or more other operations described herein.

In some aspects, the UE 120 may include a communication manager 150. As described in more detail elsewhere herein, the communication manager 150 may receive, from a first network node, configuration information that is configured to enable the UE to establish a connection with a second network node, wherein the UE is configured to operate in a location resolution operational state, and wherein the configuration information is associated with the location resolution operational state; and transmit, to the second network node, a message for establishing the connection to an NTN cell (e.g., the cell 130c) supported by the second network node, in accordance with the configuration information. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

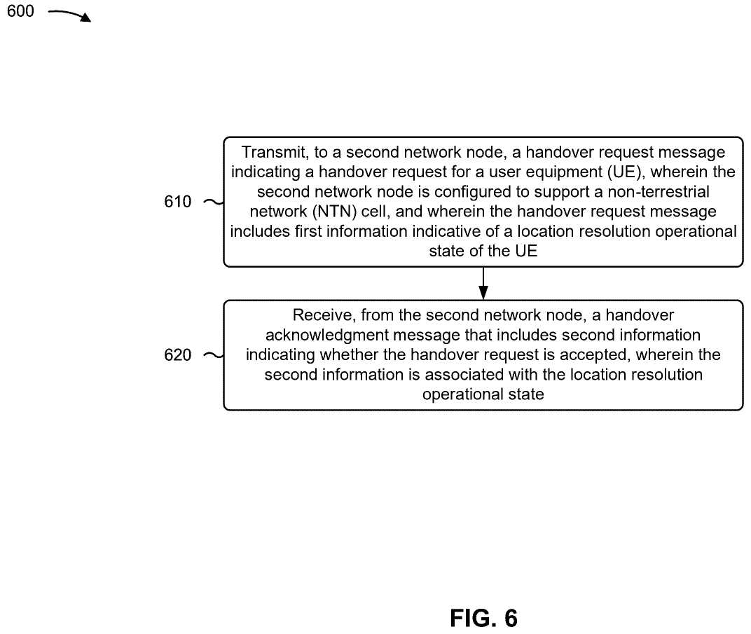

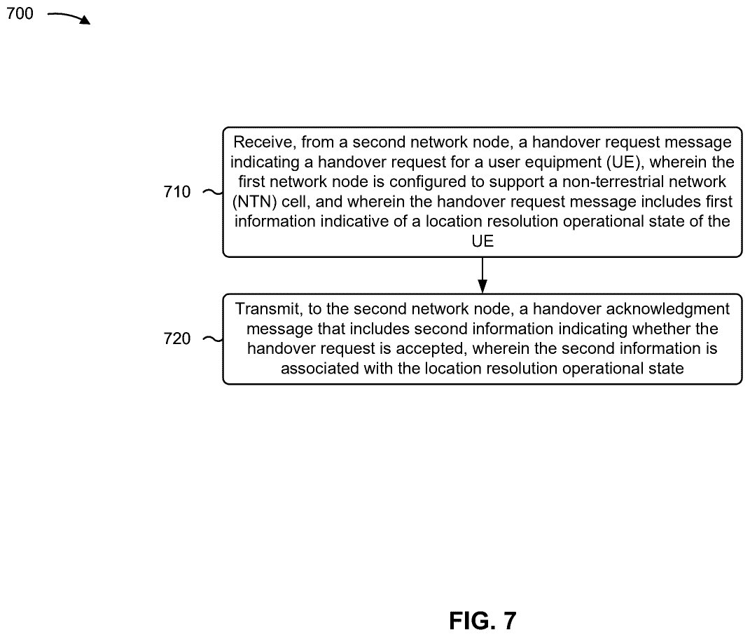

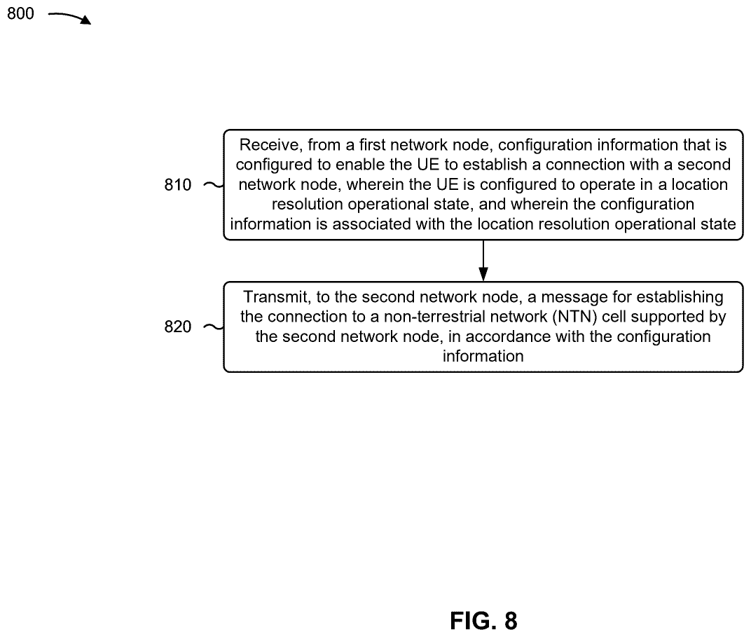

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a handover with location state information, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, or other processes as described herein. In some examples, executing instructions may include running the instructions, converting the instructions, compiling the instructions, and/or interpreting the instructions, among other examples.

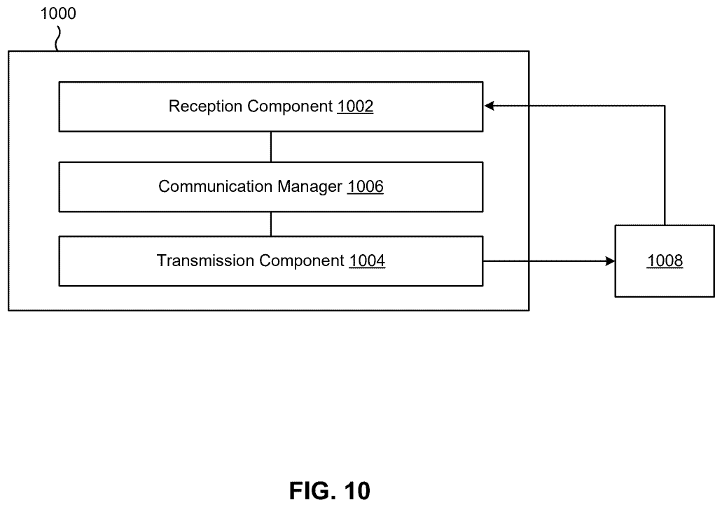

In some aspects, a first network node (e.g., the network node 110) includes means for transmitting, to a second network node, a handover request message indicating a handover request for a UE, wherein the second network node is configured to support an NTN cell, and wherein the handover request message includes first information indicative of a location resolution operational state of the UE; and/or means for receiving, from the second network node, a handover acknowledgment message that includes second information indicating whether the handover request is accepted, wherein the second information is associated with the location resolution operational state. Additionally, or alternatively, the first network node includes means for receiving, from a second network node, a handover request message indicating a handover request for a UE, wherein the first network node is configured to support an NTN cell, and wherein the handover request message includes first information indicative of a location resolution operational state of the UE; and/or means for transmitting, to the second network node, a handover acknowledgment message that includes second information indicating whether the handover request is accepted, wherein the second information is associated with the location resolution operational state. The means for the first network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

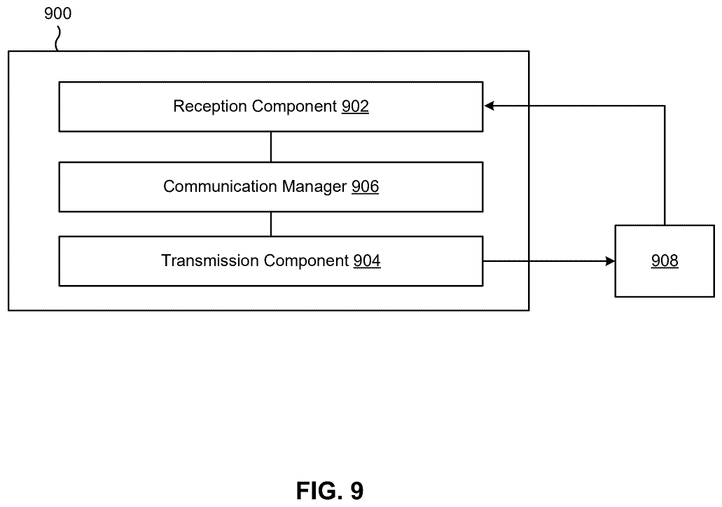

In some aspects, a UE (e.g., the UE 120) includes means for receiving, from a first network node, configuration information that is configured to enable the UE to establish a connection with a second network node, wherein the UE is configured to operate in a location resolution operational state, and wherein the configuration information is associated with the location resolution operational state; and/or means for transmitting, to the second network node, a message for establishing the connection to an NTN cell supported by the second network node, in accordance with the configuration information. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

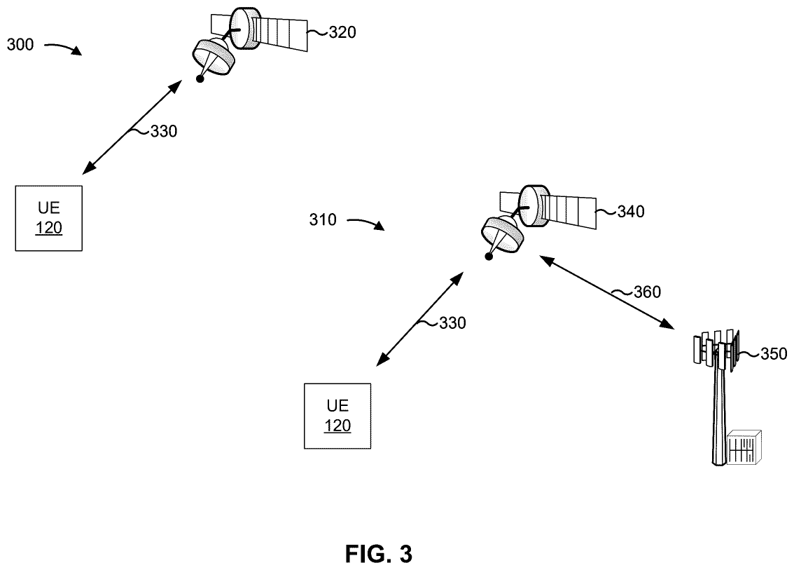

FIG. 3 is a diagram illustrating an example 300 of a regenerative satellite deployment and an example 310 of a transparent satellite deployment in a non-terrestrial network.

Example 300 shows a regenerative satellite deployment. In example 300, a UE 120 is served by a satellite 320 via a service link 330. For example, the satellite 320 may include a network node 110 (e.g., network node 110a) or a gNB. In some examples, the satellite 320 may be referred to as a non-terrestrial base station, a regenerative repeater, or an on-board processing repeater. In some examples, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some examples, the satellite may frequency convert the uplink radio frequency transmission received on the service link 330 to a frequency of the uplink radio frequency transmission on the feeder link 360, and may amplify and/or filter the uplink radio frequency transmission. In some examples, the UEs 120 shown in example 300 and example 310 may be associated with a GNSS capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

GNSS technology enables a UE (e.g., a UE 120) and/or a network node (e.g., the satellite 320, the satellite 340, the gateway 350, and/or a network node 110) to obtain precise timing and frequency synchronization within wireless communication networks, such as an NTN network and/or the wireless communication network 100. GNSS (e.g., which may include systems, such as GPS, the Galileo navigation satellite system, the BeiDou navigation satellite system, and/or other types of navigation satellite systems) offers highly accurate time and frequency information by utilizing signals from a constellation of orbiting satellites. When a UE possesses GNSS capabilities, the UE can leverage these satellite signals to obtain precise timing information, which can then be used to synchronize an internal clock of the UE. This synchronization facilitates one or more operations, such as handovers, random access procedures, and/or maintaining accurate uplink and downlink transmissions, among other examples. A network node (e.g., the satellite 320, the satellite 340, the gateway 350, and/or a network node 110) can also utilize GNSS signals to achieve a high degree of timing and frequency accuracy. This synchronization allows for coherent communication across a wireless communication network, reducing timing mismatches between network nodes and UEs. By providing a common time reference (such as a coordinated universal time (UTC)), GNSS technology ensures that all devices within the wireless communication network adhere to the same timing standard, which enables the efficient utilization of shared communication resources and advanced features, such as beamforming, carrier aggregation, and/or precise location-based services, among other examples.

In some examples, a UE may operate without access to a GNSS. A UE operating without access to a GNSS may be referred to as a “GNSS-less UE.” For example, the UE may operate in a location resolution operational state. The location resolution operational state may indicate a location resolution capability of the UE and/or a current connection status of the UE to a system via which the UE can obtain or determine a location of the UE, such as a GNSS. For example, the location resolution operational state may indicate that the UE does not support GNSS (e.g., and does not have access to a GNSS). As another example, the location resolution operational state may indicate that the UE supports GNSS, but does not currently have access to a GNSS. As another example, the location resolution operational state may indicate that the UE supports GNSS and currently has access to a GNSS. Although some examples are described herein using GNSS as an example system via which the UE can obtain location information for the UE, the aspects and techniques described herein may be similarly applied for any system via which the UE can obtain location information for the UE, such as a navigation system, a location system, a position, navigation, and timing (PNT) system, and/or a navigation satellite system, among other examples. For example, “location resolution operational state” may be referred to as a location service state, a GNSS operational state, a navigation system operational state, a positioning system operational state, a satellite navigation system operational state, a geo-positioning system status, a location service state, a PNT system status, among other examples. For example, the UE may obtain location resolution data by measuring one or more signals transmitted by a GNSS.

A UE may operate without access to a GNSS because the UE is operating in an area without, or with limited, access to a GNSS, such as in an underground environment (e.g., a tunnel), an indoor environment, a remote environment, and/or in an area for which the GNSS does not provide coverage. As another example, the UE may operate without access to the GNSS in emergency or disaster situations (e.g., in which the GNSS is down or otherwise not providing service for the UE). In some examples, the UE may operate in a location resolution operational state in which the UE does not have access to the GNSS for power savings (e.g., the UE may be capable of communicating with a GNSS, but may operate without accessing the GNSS to conserve power resources).

For example, the UE may operate in an NTN without access to a GNSS. A connection without GNSS may improve coverage for the UE (e.g., instead of, or in addition to, a connection with GNSS), such as for areas or situations without GNSS coverage. While operating in a location resolution operational state without access to a GNSS, the UE and a network node may maintain a closed-loop timing control loop and/or a closed-loop frequency control loop (e.g., may maintain closed-loop timing and frequency adjustments). For example, a timing adjustment and/or frequency adjustment may be maintained by the UE and the network node. The network node may adjust an uplink timing and/or frequency compensation via one or more messages transmitted to the UE, such as a MAC-CE or another type of message.

Additionally, or alternatively, one or more parameters for random access procedures may be defined for UEs operating without access to a GNSS. For example, separate RACH or PRACH resources (e.g., RACH occasions, preambles, or other resources) may be configured for UEs operating without access to a GNSS (e.g., first PRACH resources may be configured for UEs operating without access to a GNSS and second PRACH resources may be configured for UEs operating with access to a GNSS). As another example, a partition of RACH or PRACH resources may be configured for UEs operating without access to a GNSS. This enables RACH or PRACH resources to be configured for the UE that are more robust to timing and/or frequency misalignments, which may be more likely to occur when the UE is operating without access to a GNSS. As another example, the network node may transmit, and the UE (e.g., operating without access to a GNSS) may receive, a random access response (RAR) that includes a frequency adjustment. For example, the UE may expect to receive a frequency adjustment when performing a RACH procedure while operating in a location resolution operational state without access to a GNSS. As another example, the UE may use (e.g., apply) a cell-specific timing adjustment and/or a cell-specific frequency adjustment for transmissions when performing a RACH procedure. For example, cell-specific timing and/or frequency adjustments may be configured and/or indicated for random access for UEs operating without access to a GNSS. As another example, when the UE is operating in a connected mode (e.g., an RRC connected mode), the UE may receive dedicated timing and/or frequency adjustments for random access (e.g., for contention-free random access and/or contention-based random access). The dedicated timing and/or frequency adjustments may be configured for the UE. The dedicated timing and/or frequency adjustments may be cell-specific, UE dedicated, and/or derived from an accumulated frequency adjustment and/or timing adjustment, among other examples.

As indicated above, FIG. 3 is provided as an example. Other examples may differ from what is described with regard to FIG. 3.

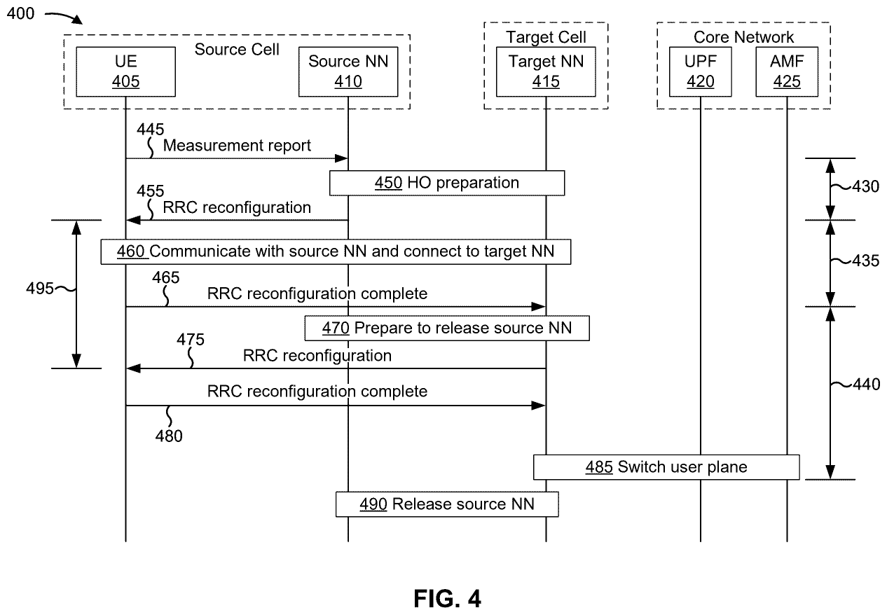

FIG. 4 is a diagram illustrating an example of handover procedure 400, in accordance with the present disclosure.

The handover procedure 400 may be an example of a make-before-break (MBB) handover procedure. As shown in FIG. 4, the handover procedure 400 may involve a UE 405, a source network node 410, a target network node 415, a user plane function (UPF) device 420, and an access and mobility management function (AMF) device 425. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions. The handover procedure 400 may include an enhanced MBB (eMBB) handover procedure.

As shown, the handover procedure 400 may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward stored communications associated with the UE 405 to the target network node 415, and the UE 405 may be released from a connection with the source network node 410.

As shown by reference number 445, the UE 405 may perform one or more measurements, and may transmit a measurement report to the source network node 410 based at least in part on performing the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, then the source network node 410 may trigger a handover of the UE 405 to the target network node 415.

As shown by reference number 450, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an ACK indication to the source network node 410 in response to the handover request.

As shown by reference number 455, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a RACH preamble assignment for accessing the target network node 415. Reception of the RRC reconfiguration message, including the handover command, by the UE 405 may trigger the start of the handover execution phase 435.

As shown by reference number 460, during the handover execution phase 435 of the MBB handover, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal) to the source network node 410, and/or may receive downlink data, downlink control information, and/or a downlink reference signal from the source network node 410.

As shown by reference number 465, upon successfully establishing a connection with the target network node 415 (e.g., via a random access procedure), the UE may transmit an RRC reconfiguration completion message to the target network node 415. Reception of the RRC reconfiguration message by the target network node 415 may trigger the start of the handover completion phase 440.

As shown by reference number 470, the source network node 410 and the target network node 415 may communicate with one another to prepare for release of the connection between the source network node 410 and the UE 405. In some examples, the target network node 415 may determine that a connection between the source network node 410 and the UE 405 is to be released, such as after receiving the RRC reconfiguration message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405. Additionally, or alternatively, the source network node 410 may notify the target network node 415 regarding a PDCP status associated with the UE 405 and/or a sequence number to be used for a downlink communication with the UE 405.

As shown by reference number 475, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, the UE may transmit an RRC reconfiguration completion message to the target network node 415 to indicate that the connection between the source network node 410 and the UE 405 is being released or has been released.

As shown by reference number 485, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the handover procedure 400, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

In some examples, the UE 405, the source network node 410, and/or the target network node 415 may use location resolution data for timing and/or frequency synchronization during the handover procedure 400. However, a dependency on location resolution data for a handover operations imposes challenges, such as when the UE is operating in a location resolution operational state in which the UE does not have access to location resolution data (e.g., due to the UE not supporting a GNSS capability or when the UE is temporarily operating without access to GNSS for one or more reasons, such as power saving). In such examples, the handover operation from a source network node to a target network node may be hindered or degraded by the absence of precise location and timing information, such as when the UE does not have access to location resolution data. This leads to complications in configuring random access resources and/or compensating timing and frequency adjustments during the handover operation. For example, the target network node may assume that the UE has access to location resolution data during the handover operation and/or may not receive location resolution data (e.g., indicating the location or position of the UE) as part of the handover operation. This may degrade performance of the handover operation, such as for scenarios in which there are large timing and/or frequency offsets or adjustments for a communication link (e.g., NTN deployments, high-mobility scenarios (e.g., high-speed train scenarios), or other scenarios).

Moreover, potential misconfigurations during handover may cause the target network node to treat a UE as having access to location resolution data, leading to potential handover failures (e.g., due to timing misalignments and/or frequency misalignments cause by the lack of location resolution data at the UE). Such misalignments between the UE's location resolution operational state and the expectation of the target network node can result in inefficiencies and disruptions in service continuity during handovers.

As indicated above, FIG. 4 is provided as an example. Other examples may differ from what is described with respect to FIG. 4.

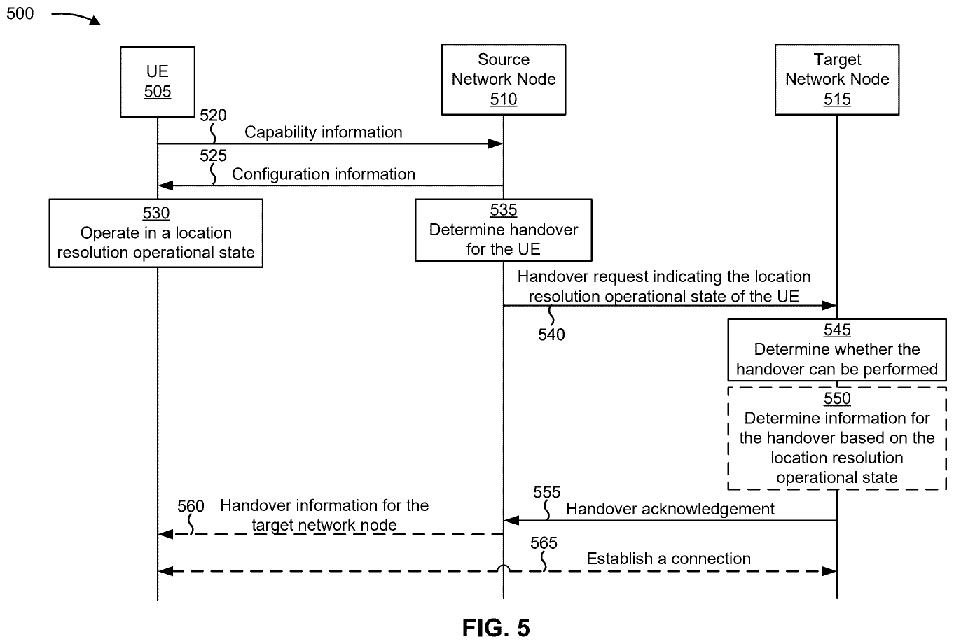

FIG. 5 is a diagram of an example 500 associated with a handover with location state information, in accordance with the present disclosure. As shown in FIG. 5, a UE 505 (e.g., a UE 120), a source network node 510 (e.g., network node 110, a CU, a DU, and/or an RU), and a target network node 515 (e.g., network node 110, a CU, a DU, and/or an RU) may communicate with each other. In some aspects, the source network node 510, the target network node 515, and the UE 505 may be part of a wireless network (e.g., wireless communication network 100). The UE 505 and the source network node 510 may have established a wireless connection prior to operations shown in FIG. 5.

In some aspects, the UE 505 may be configured to operate in an NTN cell, such as the cell 130c. For example, the target network node 515 may support an NTN cell. The target network node 515 may be an NTN network node. In some examples, the target network node 515 may be, or may be included in, a satellite, such as the satellite 320 or the satellite 340. Although an NTN is used in some examples described herein, the described techniques and aspects may be similarly applicable to other types of networks, such as terrestrial networks. For example, the techniques and aspects described herein may be applicable in high-mobility scenarios or deployments, high-Doppler scenarios, and/or other scenarios associated with large timing offsets or frequency offsets between the UE 505 and the source network node 510.

The source network node 510 may be an NTN network node. For example, the source network node 510 may support a different NTN cell from the NTN cell supported by the target network node 515. Alternatively, the source network node 510 may be a terrestrial network node (e.g., and may support a terrestrial cell, such as the cell 130a). For example, the UE 505 may operate in an NTN cell supported by the source network node 510. Alternatively, the UE 505 may operate in an terrestrial network cell supported by the source network node 510.

In some aspects, as shown by reference number 520, the UE 505 may transmit, and the source network node 510 may receive, capability information. The capability information may be included in a capability report. The UE 505 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), and/or a physical sidelink shared channel (PSSCH), among other examples. The capability information may indicate one or more parameters associated with respective capabilities of the UE 505. The one or more parameters may be indicated via respective information elements (IEs) included in a capability report.

The capability information may indicate whether the UE 505 supports a feature and/or one or more parameters related to the feature. For example, the capability information may indicate a capability and/or parameter for one or more location resolution operational states. As another example, the capability information may indicate a capability and/or parameter for whether the UE 505 supports a GNSS operation (e.g., whether the UE 505 supports accessing a GNSS and/or location resolution data). One or more operations described herein may be based on capability information. For example, the UE 505 may perform a communication in accordance with the capability information, or may receive configuration information that is in accordance with the capability information. In some aspects, the capability information may indicate UE support for performing a handover in a location resolution operational state in which the UE 505 does not have a connection with a GNSS (e.g., in which the UE 505 does not have access to a GNSS or location resolution data). In some aspects, the capability information may indicate a location resolution operational state that the UE 505 is currently operating in.

The location resolution operational state(s) may include a first location resolution operational state associated with the UE 505 not supporting a GNSS capability. When operating in the first location resolution operational state, the UE 505 may not be capable of accessing or connecting with a GNSS (e.g., to obtain location and/or position information of the UE 505). The location resolution operational state(s) may include one or more location resolution operational states associated with the UE 505 supporting a GNSS capability. For example, when operating in a second location resolution operational state, the UE 505 may be capable of (or may support) accessing or connecting with a GNSS (e.g., to obtain location and/or position information of the UE 505), but may not currently have an active connection with a GNSS (e.g., the UE 505 may not connect or obtain location resolution data from a GNSS for one or more reasons, such as power saving). When operating in a third location resolution operational state, the UE 505 may be capable of (or may support) accessing or connecting with a GNSS (e.g., to obtain location and/or position information of the UE 505), and may currently have an active connection with a GNSS. When operating in the third location resolution operational state, the UE 505 may be configured to obtain location resolution data (e.g., indicative of location information for the UE 505) via the GNSS.

The source network node 510 may determine configuration information for the UE 505 based on, in response to, or otherwise associated with, the capability information. For example, if the capability information indicates that the UE 505 is operating in, or supports, the first location resolution operational state or the second location resolution operational state (e.g., GNSS-less states), then the source network node 510 may determine configuration information to facilitate the UE 505 operating without access to location resolution data. For example, the source network node 510 may determine random access configuration information, timing adjustment information, and/or frequency adjustment information, among other examples (e.g., in a similar manner as described in connection with FIG. 3) for the UE 505. In other examples, the source network node 510 may determine the configuration information without, or independent of, the capability information.

In some aspects, as shown by reference number 525, the source network node 510 may transmit, and the UE 505 may receive, configuration information. In some aspects, the UE 505 may receive the configuration information via one or more of system information signaling (e.g., a master information block (MIB) and/or a system information block (SIB), among other examples), RRC signaling, MAC signaling (e.g., one or more MAC-CEs), and/or lower layer signaling (e.g., DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 505. For example, in some aspects, the configuration information may at least partially be defined by a wireless communication standard, such as the 3GPP. In such examples, the source network node 510 may not explicitly indicate such configuration information to the UE 505. For example, the UE 505 may optionally obtain at least a portion of the configuration information from a configuration stored by the UE 505 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 505 may perform a handover operation in one or more location resolution operational states. For example, the configuration information may indicate that the UE 505 may perform a handover operation (such as the handover process 400) while operating in a location resolution operational state in which the UE 505 does not have access to a GNSS or location resolution data.

The UE 505 may configure itself based at least in part on the configuration information. In some aspects, the UE 505 may be configured to perform one or more operations described herein based at least in part on the configuration information.

As shown by reference number 530, the UE 505 may operate in a location resolution operational state, such as the first location resolution operational state, the second location resolution operational state, or the third location resolution operational state described herein, among other examples. The location resolution operational state indicates whether the UE 505 is currently capable of accessing location resolution data, which may impact a handover process. In some aspects, the location resolution operational state may indicate that the UE 505 does not currently have access to a GNSS or location resolution data, which may be referred to as a GNSS-less state. For example, the UE 505 may not support a GNSS capability and/or may have refrained from connecting to or accessing a GNSS, such as for power savings.

In some aspects, the source network node 510 may identify the location resolution operational state of the UE 505. The source network node 510 may determine the current location resolution operational state of the UE 505 by utilizing the capability information and/or one or more communications from the UE 505. The UE 505 may periodically transmit capability information to the source network node 510 indicating a current GNSS connection status (e.g., which may be indicative of the current location resolution operational state of the UE 505). The capability information may include one or more parameters, such as whether the UE 505 has a GNSS capability but currently does not have an active connection with a GNSS, or if the UE 505 is in an active location resolution operational state. The source network node 510 may use the capability information to determine the location resolution operational state of the UE 505.

Additionally, the source network node 510 may monitor ongoing signaling and measurement reports from the UE 505 to track any changes in the location resolution operational state of the UE 505. For example, if the UE 505 loses a GNSS connection due to entering a tunnel or indoor environment, the UE 505 may transmit an update to the source network node 510 indicating the loss of GNSS connection. The network node 510 can then update the location resolution operational state of the UE 505 to reflect the current operational conditions, ensuring that any handover requests or configurations are tailored to the current GNSS operational state of the UE 505. By maintaining an up-to-date understanding of the location resolution operational state of the UE 505, the source network node 510 can facilitate a more effective and reliable handover processes for the UE 505.

In some aspects, the source network node 510 may perform closed-loop frequency and/or timing tracking for the UE 505 (e.g., if the UE 505 is operating in a location resolution operational state without access to the GNSS or location resolution data). The source network node 510 and the UE 505 may perform closed-loop frequency and timing tracking to maintain synchronization for reliable communication, such as in an NTN where signal propagation delays and Doppler shifts are significant. For example, the UE 505 may transmit uplink signals that include reference signals to the source network node 510. The source network node 510 may measure the timing offset and/or the frequency offset from these reference signals, and the source network node 510 may determine adjustments (e.g., timing and/or frequency adjustments) needed to align the transmissions from the UE 505 accurately with the scheduling from the source network node 510.

The source network node 510 may transmit, and the UE 505 may receive, the timing adjustment(s) and/or the frequency adjustment(s) via one or more control messages, such as one or more MAC-CEs or RRC signaling. The timing adjustment(s) and/or the frequency adjustment(s) may indicate a timing advance and frequency correction values to be applied by the UE 505. The UE 505 may apply these adjustments to subsequent transmissions, ensuring that the signals are received within the expected time and frequency windows by the source network node 510. This feedback loop may continue, with the source network node 510 periodically updating the adjustments based on the latest measurements of the transmissions from the UE 505.

Both the source network node 510 and the UE 505 may accumulate and store timing and frequency adjustments to maintain a stable communication link and to facilitate handovers. The UE 505 may store a record of the cumulative timing advance (TA) and frequency offset (FO) values that the UE 505 has applied over time. This record may help the UE 505 in quickly aligning transmissions from the UE 505 if temporary discrepancies occur, such as during brief signal obstructions or rapid movement. The source network node 510 may similarly store a log of these adjustments for the UE 505. This data may be useful during handover procedures, such as when preparing a handover request to the target network node 515. For example, the source network node 510 can include the accumulated timing and frequency adjustment values in the handover request to facilitate the handover, as explained in more detail elsewhere herein. The target network node 515 can then use this information to pre-configure the handover parameters, ensuring minimal disruption and maintaining synchronization during and after the handover. This stored adjustment information also enables the network to handle GNSS-less operation scenarios more effectively by relying on historical data to maintain accurate timing and frequency alignment.

As shown by reference number 535, the source network node 510 may determine a handover for the UE 505. For example, the UE 505 may perform one or more measurements (e.g., serving cell measurements and/or neighbor cell measurements), and may transmit a measurement report to the source network node 510 based on performing the one or more measurements. The measurement report may indicate, for example, an RSRP parameter, an RSRQ parameter, RSSI parameter, and/or an SINR parameter (e.g., for the serving cell and/or one or more neighbor cells). The source network node 510 may use the measurement report to determine whether to trigger a handover to the target network node 515. For example, if one or more measurements satisfy a condition, then the source network node 510 may trigger a handover of the UE 505 to the target network node 515.

As shown by reference number 540, the source network node 510 may transmit, and the target network node 515 may receive, a handover request message. The source network node 510 may transmit the handover request message via a backhaul link, a midhaul link, an Xn interface, and/or another signaling mechanism. The handover request message may be transmitted by the source network node 510 during a handover preparation phase, such as the handover preparation phase 430.

The handover request message may indicate the location resolution operational state of the UE 505. For example, the handover request message may indicate whether the UE 505 currently has access to location resolution data (e.g., has an active connection with a GNSS). For example, the handover request message may include a transparent RRC container with information to prepare the handover at the target network node 515. The transparent RRC container may indicate the location resolution operational state of the UE 505 (e.g., may indicate whether the UE 505 currently has access to location resolution data). The transparent RRC container may indicate other information, such as a target cell ID, an identifier of the UE 505 (e.g., a cell radio network temporary identifier of the UE 505), a radio resource management configuration of the UE 505 (such as a UE inactive time, antenna configuration information, and/or downlink carrier frequency information), a current quality of service (QoS) flow to data radio bearer (DRB) mapping rule(s) applied to the UE 505, system information (e.g., a SIB type 1 (SIB1) or another SIB) of the source network node 510, one or more UE capabilities for different RATs, packet data unit (PDU) session information for the UE 505 (e.g., slice information and/or QoS flow level QoS profile(s)), and/or measurement information associated with the UE 505 (e.g., beam measurement information, if available), among other examples.

In some aspects, the handover request message may include assistance information associated with time-frequency pre-compensation for the UE 505. The assistance information may be included in the transparent RRC container of the handover request message. The assistance information may include an estimated location of the UE 505 (e.g., within an NTN cell) with some uncertainty level. For example, the source network node 510 may determine or estimate the estimated location of the UE 505 based on historical closed-loop timing adjustments and/or frequency adjustments with the UE 505. Additionally, the source network node 510 may determine or estimate the estimated location of the UE 505 based on measurement information provided by the UE 505. The estimated location of the UE 505 may facilitate the target network node 515 determining timing and/or frequency adjustments for the UE 505 to be applied as part of the handover operation.

Additionally, or alternatively, the assistance information may include accumulated timing adjustment information and/or frequency adjustment information for the UE 505. This accumulated information may facilitate the synchronization of UE 505 with the target network node 515 during the handover operations. Accumulated timing adjustment information refers to the total timing corrections (e.g., one or more TAs) that have been applied to transmissions of the UE 505 over time to ensure that uplink signals align with scheduling from the source network node 510. The timing corrections may include corrections for propagation delays that change as the distance between the UE 505 and the source network node 510 changes, such as in the NTN where such delays are more significant.

Additionally, accumulated frequency adjustment information may include the total frequency corrections that have been applied to counteract Doppler shifts and other frequency variations that occur due to the relative motion between the UE 505 and the source network node 510. As the UE 505 moves, the frequency of transmitted signals can shift, and continuous frequency adjustments enable these frequencies to be kept within acceptable ranges for reliable communication. By providing this accumulated frequency adjustment information in the assistance information, the source network node 510 can ensure that the target network node 515 has information to quickly and accurately synchronize with the UE 505 during a handover operation. This allows for a smoother handover process with minimal disruption to ongoing communication sessions, as the target network node 515 can pre-apply the necessary corrections before establishing a new connection with the UE 505. This improves the likelihood of service continuity and quality of experience in dynamic and challenging environments, such as NTNs and high-mobility terrestrial networks.

Additionally, or alternatively, the assistance information may include measurement information provided by the UE 505. For example, the measurement information may be associated with one or more narrow beams of the UE 505. As used herein, “narrow” beam may refer to a beam that is a highly directional radio signal transmission that is focused into a small, concentrated area. Unlike wide beams, which cover larger and broader areas, narrow beams are designed to limit the spread of the radio signal, concentrating the transmission power and energy in a specific direction. This focused transmission enhances signal strength and quality over the targeted area, reducing interference and potential signal degradation from other sources. Measurement information from one or more narrow beams may enable the target network node 515 to obtain information for narrower signal directions, thereby improving beamforming determinations by the target network node 515 for the handover operation.

As shown by reference number 545, the target network node 515 may determine whether the handover can be performed. For example, the target network node 515 may determine whether to accept or reject the handover based on the handover request message. In some aspects, the target network node 515 may determine whether to accept or reject the handover based on the location resolution operational state of the UE 505. For example, in some cases, the target network node 515 may support handovers for UEs in the location resolution operational state (e.g., a GNSS-less operational state). In such examples, the target network node 515 may determine to accept the handover request.

In other examples, the target network node 515 may not support handovers for UEs in the location resolution operational state. For example, the target network node 515 may not support handovers for UEs that do not have access to location resolution data and/or that do not have an active connection to a GNSS. In such examples, the target network node 515 may determine to reject the handover request.

In some aspects, the target network node 515 may determine whether to accept or reject the handover based on the assistance information. For example, if an adjustment (e.g., an accumulated frequency adjustment and/or an accumulated timing adjustment) indicated by the assistance information satisfies a threshold, then the target network node 515 may determine to reject the handover request. If the adjustment (e.g., an accumulated frequency adjustment and/or an accumulated timing adjustment) indicated by the assistance information does not satisfy the threshold, then the target network node 515 may determine to accept the handover request.

The target network node 515 may determine whether to accept or reject the handover as part of an admission control operation for the handover. Admission control of handover involves the target network node 515 evaluating and deciding whether to allow a UE to transfer a connection from one network node to another, based on the current network resources and conditions. This process ensures that the target network node 515 has sufficient capacity and resources to accommodate the new connection without degrading the quality of service for existing UEs in the cell supported by the target network node 515. Effective admission control during handovers enables the target network node 515 to maintain network stability, prevent overload, and/or ensure a seamless transition for the UE 505, thereby enhancing the overall user experience.

As shown by reference number 550, the target network node 515 may determine information for the handover based on the location resolution operational state and/or the assistance information. The information for the handover may be referred to herein as “handover information.” The target network node 515 may determine the handover information if the target network node 515 accepts the handover request. The handover information may include configuration information (e.g., an RRC configuration) for the UE 505 that is configured to enable or facilitate the UE 505 connecting with the target network node 515 while the UE 505 is operating in the location resolution operational state. For example, the target network node 515 (e.g., a CU of the target network node 515) may prepare an RRC configuration (e.g., an RRC reconfiguration with synchronization, such as indicated by an RRCReconfigurationwithSync IE). The RRC configuration may include or indicate the handover information.

In some examples, the handover information may include a random access configuration that is configured based on the location resolution operational state. For example, the random access configuration may include a PRACH configuration for the location resolution operational state in which the UE 505 is currently operating. A random access configuration (e.g., a PRACH configuration) for a GNSS-less operational state may be designed to enable the UE 505 to perform random access operations effectively without relying on GNSS-derived timing information or location information. For example, the random access configuration may indicate one or more random access preambles dedicated specifically for GNSS-less operation. The one or more random access preambles may be designed with unique sequences that are more robust to timing and frequency offsets, which are typical without location resolution data. Additionally, the subcarrier spacing and frequency ranges indicated by the random access configuration may be adjusted to compensate for the larger timing and frequency uncertainties inherent in a GNSS-less operational state, ensuring that the transmitted signals can still be received and processed accurately by the target network node 515 during random access.

Additionally, the random access configuration may include predefined time-frequency pre-compensation values that the UE 505 can apply before transmitting a preamble. This may enable transmitted signals to better align with an expected reception window of the target network node 515, mitigating the absence of GNSS-based synchronization. The random access configuration may indicate specific time and frequency resources allocated for PRACH transmissions in the GNSS-less state, including defined slots, subframes, and frequency blocks, which may reduce contention and improve access success rates for random access for the UE 505 operating without access to location resolution data.

Additionally, the random access configuration may indicate one or more backoff parameters and/or initial timing advance values associated with (e.g., optimized for) GNSS-less operation, assisting in managing the timing of random access attempts and subsequent transmissions to enhance synchronization likelihood. The random access configuration may indicate one or more contention resolution timers to resolve contention among multiple UEs attempting random access simultaneously, coordinating the access procedures more effectively when precise timing information is less reliable. By incorporating these elements in the random access configuration, the random access configuration may ensure that the UE 505 can maintain efficient and reliable communication with the target network node 515 during random access in the absence of GNSS-based timing and synchronization.

The handover information may include a PRACH configuration supported for a GNSS-less operational state and one or more additional PRACH configurations for one or more other location resolution operational states (and/or for legacy operation). The random access configuration(s) may be included in the handover information. For example, the RRC configuration (e.g., an RRC reconfiguration with synchronization, such as indicated by an RRCReconfigurationwithSync IE) may include the random access configuration(s), such as in a dedicated random access configuration (e.g., as indicated by an RACHConfigDedicated IE).

Additionally, or alternatively, the handover information may include one or more adjustment values to be applied by the UE 505. For example, the one or more adjustment values may include a timing adjustment value (e.g., a TA value) and/or a frequency adjustment value (e.g., an FO value). The one or more adjustment values may be adjustment value(s) to be applied by the UE 505 during a random access procedure with the target network node 515. The target network node 515 may determine the one or more adjustment values based on the assistance information included in the handover request message, as described elsewhere herein.

Additionally, or alternatively, the handover information may include an indication to flush the accumulated adjustment values at the UE 505. This means that the handover command from the target network node 515 (e.g., as forwarded or provided by the source network node 510) to the UE 505 may instruct the UE 505 to discard all previously stored timing and frequency adjustment values. Flushing these accumulated adjustments ensures that the UE 505 resets one or more synchronization parameters and starts fresh with new synchronization parameters for the target network node 515. This may be beneficial in scenarios where the accumulated adjustments might cause misalignment or errors when transitioning to communicating with the target network node 515 due to changes in the network environment, Doppler shifts, and/or propagation delays, among other examples.

By including the indication to flush the accumulated adjustment values in the handover information, the target network node 515 may ensure that the UE 505 recalibrates synchronization based on the current conditions associated with the target network node 515, rather than relying on potentially outdated or irrelevant data. This process helps in preventing any residual errors that might have been carried over from previous adjustments, thereby enhancing the accuracy and reliability of the communication link post-handover. Additionally, this may enable a smoother and more seamless transition, minimizing the risk of synchronization misalignments and maintaining the quality of service for the UE 505.

Additionally, or alternatively, the handover information may include an indication that the UE 505 is to determine (e.g., derive or calculate) one or more adjustment values based on one or more accumulated adjustment values and one or more correction values. For example, the target network node 515 may determine the one or more correction values (e.g., based on the location resolution operational state and/or the assistance information in the handover request message). This may indicate that instead of discarding the accumulated adjustments entirely, the UE 505 can use the accumulated adjustments as a baseline to make more precise adjustments (e.g., by applying the one or more correction values to the accumulated adjustments). By leveraging past adjustment data, the UE 505 can quickly adapt to the synchronization requirements of the target network node 515 without starting from scratch. This approach combines the historical data's benefits with real-time corrections, ensuring a seamless and efficient transition during handover.

For example, the target network node 515 may determine the one or more correction values based on the location resolution operational state and/or the assistance information in the handover request message. These correction values may be fine-tuned adjustments that account for the current network conditions, such as a location of the target network node 510, signal propagation characteristics, and/or any Doppler effects due to relative movement of the target network node 510 and/or the UE 505, among other examples. By providing the UE 505 with these correction value(s) (e.g., in the handover information), the target network node 515 may ensure that the derived adjustment value(s) at the UE 505 are accurate and tailored to the conditions associated with the target network node 515.

Additionally, or alternatively, the handover information may indicate that the UE 505 is to use a subset of random access resources from a set of random access resources. A random access resource may include a preamble, a PRACH occasion, and/or another resource used as part of a random access procedure. This targeted allocation of random access resources can help streamline the random access procedure, improving efficiency and reducing potential collisions with other UEs attempting to access the network simultaneously. Moreover, the subset of random access resources may be configured to be more resilient to timing and/or frequency misalignments between the UE 505 and the target network node 515.

In some aspects, the UE 505 may be operating in a location resolution operational state associated with the UE 505 supporting a GNSS capability, but the UE 505 not having a current active connection with a GNSS. In such examples, the target network node 515 may determine that the UE 505 is to connect with the target network node 515 in a different location resolution operational state. For example, the target network node 515 may determine that the UE 505 (e.g., that is capable of supporting GNSS) is to obtain location resolution data (e.g., is to connect to a GNSS) prior to establishing a connection with the target network node 515. In such examples, the handover information may not include a random access configuration that is explicitly configured for GNSS-less operation. This may be indicative to the UE 505 that the UE 505 is to obtain or acquire location resolution data and perform a random access procedure with the target network node 515 in a location resolution operational state that is associated with the UE 505 having access to the location resolution data.

As shown by reference number 555, the target network node 515 may transmit, and the source network node 510 may receive, a handover acknowledgement. The handover acknowledgement may indicate whether the handover request is accepted or rejected. For example, if the target network node 515 determines to reject the handover request (e.g., as described in connection with reference number 545), then the handover acknowledgement may indicate that the handover request is rejected. In such examples, the handover acknowledgement may indicate a cause of the rejection. For example, the cause of the rejection may be that the target network node 515 does not support the location resolution operational state of the UE 505. This enables the target network node 510 to quickly identify that the UE 505 cannot be handed over to the target network node 515 while the UE 505 is operating in the location resolution operational state. For example, the source network node 510 may refrain from transmitting a handover request message to the target network node 515 in the future for the UE 505 (or other UEs) operating in the location resolution operational state, thereby conserving network resources and/or processing resources associated with communicating the handover request message that will be rejected.

In other examples, the handover acknowledgement may indicate that the handover request is accepted. In such examples, the handover acknowledgement may indicate or include the handover information for the UE 505. The handover information may be included in a transparent container to be transmitted to the UE 505 (e.g., by the source network node 510) as an RRC message.

As shown by reference number 560, the source network node 510 may transmit, and the UE 505 may receive, the handover information for the target network node 515. For example, the source network node 510 may transmit a handover command (e.g., in an RRC message, such as indicated by an RRCReconfiguration IE). In some examples, the handover command may be indicated via an RRCReconfigurationwithSync IE. The handover information may be indicated by the handover command and/or an RRC message carrying or indicating the handover command.

For example, the handover information may indicate a random access configuration, one or more adjustment values, and/or other instructions (e.g., as described in more detail elsewhere herein) to enable or facilitate the UE 505 establishing a connection with the target network node 515.

As shown by reference number 565, the UE 505 and the target network node 515 may establish a connection. For example, the UE 505 may use the handover information to transmit a message associated with (e.g., for) initiating or establishing a connection with the target network node 515 (e.g., to a cell supported by the target network node 515). The message may be a random access message, such as a random access message that includes a preamble (e.g., configured by the random access configuration included in the handover information). Additionally, or alternatively, the UE 505 may apply one or more adjustment values (e.g., a timing adjustment value and/or a frequency adjustment value) prior to transmitting the message. For example, the UE 505 may transmit the message using timing information that is based on a correction value indicated in the handover information and/or frequency information that is based on a correction value indicated in the handover information. Additionally, or alternatively, the UE 505 may transmit the message using random access resource(s) indicated by the handover information. Additionally, or alternatively, the UE 505 may transmit the message after clearing the accumulated timing adjustment value or the accumulated frequency adjustment value. The UE 505 may transmit the message and/or establish the connection while operating in the location resolution operational state (e.g., as described in connection with reference number 530).

In some other examples, the location resolution operational state as described in connection with reference number 530 may be a first location resolution operational state, and the UE 505 may switch to operating in a second location resolution operational state (e.g., prior to initiating the establishment of the connection) based on the handover information. For example, the first location resolution operational state may be associated with the UE 505 supporting GNSS-based operation and the UE 505 not having an active connection with a GNSS, and the second location resolution operational state may be associated with the UE 505 having the active connection with the GNSS. For example, if the handover information does not include a random access configuration for the first location resolution operational state, then the UE 505 may determine that the UE 505 is to attempt to establish the connection while operating in the second location resolution operational state. As an example, the first location resolution operational state may be associated with the UE 505 not having access to location resolution data. The second location resolution operational state may be associated with the UE 505 having access to location resolution data. Prior to establishing the connection with the target network node 515 (e.g., prior to initiating a random access procedure), the UE 505 may acquire or obtain location resolution data via a GNSS. After obtaining the location resolution data, the UE 505 may transmit a message (e.g., a random access message) associated with establishing the connection with the target network node 515. This may improve the likelihood of success of establishing the connection because of the improved timing and/or location data indicated by the location resolution data, such as when the UE 505 is capable of accessing or obtaining location resolution data.

As indicated above, FIG. 5 is provided as an example. Other examples may differ from what is described with regard to FIG. 5.

FIG. 6 is a diagram illustrating an example process 600 performed, for example, at a first network node or an apparatus of a first network node, in accordance with the present disclosure. Example process 600 is an example where the apparatus or the first network node (e.g., a network node 110 or the source network node 510) performs operations associated with a handover with location state information.

As shown in FIG. 6, in some aspects, process 600 may include transmitting, to a second network node, a handover request message indicating a handover request for a UE, wherein the second network node is configured to support an NTN cell, and wherein the handover request message includes first information indicative of a location resolution operational state of the UE (block 610). For example, the first network node (e.g., using transmission component 1004 and/or communication manager 1006, depicted in FIG. 10) may transmit, to a second network node, a handover request message indicating a handover request for a UE, wherein the second network node is configured to support an NTN cell, and wherein the handover request message includes first information indicative of a location resolution operational state of the UE, as described above.

As further shown in FIG. 6, in some aspects, process 600 may include receiving, from the second network node, a handover acknowledgment message that includes second information indicating whether the handover request is accepted, wherein the second information is associated with the location resolution operational state (block 620). For example, the first network node (e.g., using reception component 1002 and/or communication manager 1006, depicted in FIG. 10) may receive, from the second network node, a handover acknowledgment message that includes second information indicating whether the handover request is accepted, wherein the second information is associated with the location resolution operational state, as described above.

Process 600 may include additional aspects, such as any single aspect or any combination of aspects described below and/or in connection with one or more other processes described elsewhere herein.

In a first aspect, the location resolution operational state includes at least one of a first location resolution operational state associated with the UE not supporting GNSS-based operation, a second location resolution operational state associated with the UE supporting GNSS-based operation and not having an active connection with a GNSS, or a third location resolution operational state associated with the UE having the active connection with the GNSS.

In a second aspect, alone or in combination with the first aspect, the location resolution operational state indicates that the UE does not have an active connection with a GNSS, the second information indicates that the handover request is accepted, the second information includes configuration information that is configured to enable the UE to establish a connection with the second network node, and the configuration information is based on the location resolution operational state.

In a third aspect, alone or in combination with one or more of the first and second aspects, process 600 includes transmitting, to the UE, the configuration information.

In a fourth aspect, alone or in combination with one or more of the first through third aspects, the configuration information includes a random access configuration that is associated with the location resolution operational state.

In a fifth aspect, alone or in combination with one or more of the first through fourth aspects, the random access configuration is configured to enable the UE to perform a random access operation with the second network node without the active connection with the GNSS.

In a sixth aspect, alone or in combination with one or more of the first through fifth aspects, the location resolution operational state is a first location resolution operational state, the random access configuration includes a first random access configuration that is configured for the first location resolution operational state and a second random access configuration that is configured for a second location resolution operational state, and the second location resolution operational state is associated with the UE having the active connection with the GNSS.

In a seventh aspect, alone or in combination with one or more of the first through sixth aspects, the random access configuration indicates a set of random access resources, and the random access configuration indicates that the UE is configured to use a subset of random access resources from the set of random access resources, where the subset of random access resources is configured for the location resolution operational state.

In an eighth aspect, alone or in combination with one or more of the first through seventh aspects, the configuration information indicates that the UE is configured to perform time-frequency pre-compensation during a random access operation in the location resolution operational state.

In a ninth aspect, alone or in combination with one or more of the first through eighth aspects, the configuration information indicates at least one of a timing adjustment value or a frequency adjustment value for a random access operation between the UE and the second network node.

In a tenth aspect, alone or in combination with one or more of the first through ninth aspects, the configuration information indicates a command to clear accumulated timing adjustment values or frequency adjustment values.

In an eleventh aspect, alone or in combination with one or more of the first through tenth aspects, the configuration information indicates a correction value that is configured for timing adjustment determination or frequency adjustment determination.

In a twelfth aspect, alone or in combination with one or more of the first through eleventh aspects, the first information includes assistance information associated with time-frequency pre-compensation for the UE.

In a thirteenth aspect, alone or in combination with one or more of the first through twelfth aspects, the assistance information indicates at least one of accumulated timing adjustment information or frequency adjustment information for the UE.

In a fourteenth aspect, alone or in combination with one or more of the first through thirteenth aspects, the assistance information includes an estimated location of the UE.

In a fifteenth aspect, alone or in combination with one or more of the first through fourteenth aspects, the second information indicates that the handover request is rejected, and the second information includes a cause indication that is indicative of the second network node not supporting handover associated with the location resolution operational state of the UE.

In a sixteenth aspect, alone or in combination with one or more of the first through fifteenth aspects, the second information indicates that the handover request is accepted, and the second information indicates that the second network node supports handover associated with the location resolution operational state of the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a first network node or an apparatus of a first network node, in accordance with the present disclosure. Example process 700 is an example where the apparatus or the first network node (e.g., a network node 110 or the target network node 515) performs operations associated with a handover with location state information.

As shown in FIG. 7, in some aspects, process 700 may include receiving, from a second network node, a handover request message indicating a handover request for a UE, wherein the first network node is configured to support an NTN cell, and wherein the handover request message includes first information indicative of a location resolution operational state of the UE (block 710). For example, the first network node (e.g., using reception component 1002 and/or communication manager 1006, depicted in FIG. 10) may receive, from a second network node, a handover request message indicating a handover request for a UE, wherein the first network node is configured to support an NTN cell, and wherein the handover request message includes first information indicative of a location resolution operational state of the UE, as described above.

As further shown in FIG. 7, in some aspects, process 700 may include transmitting, to the second network node, a handover acknowledgment message that includes second information indicating whether the handover request is accepted, wherein the second information is associated with the location resolution operational state (block 720). For example, the first network node (e.g., using transmission component 1004 and/or communication manager 1006, depicted in FIG. 10) may transmit, to the second network node, a handover acknowledgment message that includes second information indicating whether the handover request is accepted, wherein the second information is associated with the location resolution operational state, as described above.

Process 700 may include additional aspects, such as any single aspect or any combination of aspects described below and/or in connection with one or more other processes described elsewhere herein.

In a first aspect, the location resolution operational state includes at least one of a first location resolution operational state associated with the UE not supporting GNSS-based operation, a second location resolution operational state associated with the UE supporting GNSS-based operation and not having an active connection with a GNSS, or a third location resolution operational state associated with the UE having the active connection with the GNSS.

In a second aspect, alone or in combination with the first aspect, the location resolution operational state indicates that the UE does not have an active connection with a GNSS, the second information indicates that the handover request is accepted, the second information includes configuration information that is configured to enable the UE to establish a connection with the first network node, and the configuration information is based on the location resolution operational state.

In a third aspect, alone or in combination with one or more of the first and second aspects, process 700 includes receiving, from the UE, a random access message in accordance with the configuration information.

In a fourth aspect, alone or in combination with one or more of the first through third aspects, the configuration information includes a random access configuration that is associated with the location resolution operational state.

In a fifth aspect, alone or in combination with one or more of the first through fourth aspects, the random access configuration is configured to enable the UE to perform a random access operation with the first network node without the active connection with the GNSS.

In a sixth aspect, alone or in combination with one or more of the first through fifth aspects, the location resolution operational state is a first location resolution operational state, the random access configuration includes a first random access configuration that is configured for the first location resolution operational state and a second random access configuration that is configured for a second location resolution operational state, and the second location resolution operational state is associated with the UE having the active connection with the GNSS.

In a seventh aspect, alone or in combination with one or more of the first through sixth aspects, the random access configuration indicates a set of random access resources, and the random access configuration indicates that the UE is configured to use a subset of random access resources from the set of random access resources, where the subset of random access resources is configured for the location resolution operational state.

In an eighth aspect, alone or in combination with one or more of the first through seventh aspects, the configuration information indicates that the UE is configured to perform time-frequency pre-compensation during a random access operation with the first network node in the location resolution operational state.

In a ninth aspect, alone or in combination with one or more of the first through eighth aspects, the configuration information indicates at least one of a timing adjustment value or a frequency adjustment value for a random access operation between the UE and the first network node.

In a tenth aspect, alone or in combination with one or more of the first through ninth aspects, process 700 includes receiving, from the UE, a message associated with the random access operation, where the message uses at least one of timing information that is based on the timing adjustment value, or information that is based on the frequency adjustment value.

In an eleventh aspect, alone or in combination with one or more of the first through tenth aspects, the configuration information indicates a command to clear accumulated timing adjustment values or frequency adjustment values.

In a twelfth aspect, alone or in combination with one or more of the first through eleventh aspects, the configuration information indicates a correction value that is configured for timing adjustment determination or frequency adjustment determination.

In a thirteenth aspect, alone or in combination with one or more of the first through twelfth aspects, process 700 includes receiving, from the UE, a message using timing information that is based on the correction value or frequency information that is based on the correction value.

In a fourteenth aspect, alone or in combination with one or more of the first through thirteenth aspects, the first information includes assistance information associated with time-frequency pre-compensation for the UE.

In a fifteenth aspect, alone or in combination with one or more of the first through fourteenth aspects, the assistance information indicates at least one of accumulated timing adjustment information or frequency adjustment information for the UE.

In a sixteenth aspect, alone or in combination with one or more of the first through fifteenth aspects, the assistance information includes an estimated location of the UE.

In a seventeenth aspect, alone or in combination with one or more of the first through sixteenth aspects, the second information indicates that the handover request is rejected, and the second information includes a cause indication that is indicative of the first network node not supporting handover associated with the location resolution operational state of the UE.

In an eighteenth aspect, alone or in combination with one or more of the first through seventeenth aspects, the second information indicates that the handover request is accepted, and the second information indicates that the first network node supports handover associated with the location resolution operational state of the UE.

In a nineteenth aspect, alone or in combination with one or more of the first through eighteenth aspects, process 700 includes performing a handover operation with the UE in accordance with the location resolution operational state of the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., a UE 120 or the UE 505) performs operations associated with a handover with location state information.

As shown in FIG. 8, in some aspects, process 800 may include receiving, from a first network node, configuration information that is configured to enable the UE to establish a connection with a second network node, wherein the UE is configured to operate in a location resolution operational state, and wherein the configuration information is associated with the location resolution operational state (block 810). For example, the UE (e.g., using reception component 902 and/or communication manager 906, depicted in FIG. 9) may receive, from a first network node, configuration information that is configured to enable the UE to establish a connection with a second network node, wherein the UE is configured to operate in a location resolution operational state, and wherein the configuration information is associated with the location resolution operational state, as described above.

As further shown in FIG. 8, in some aspects, process 800 may include transmitting, to the second network node, a message for establishing a connection to an NTN cell supported by the second network node, in accordance with the configuration information (block 820). For example, the UE (e.g., using transmission component 904 and/or communication manager 906, depicted in FIG. 9) may transmit, to the second network node, a message for establishing a connection to an NTN cell supported by the second network node, in accordance with the configuration information, as described above.

Process 800 may include additional aspects, such as any single aspect or any combination of aspects described below and/or in connection with one or more other processes described elsewhere herein.

In a first aspect, the configuration information includes a random access configuration associated with the location resolution operational state, and the message includes a random access message that is in accordance with the random access configuration.

In a second aspect, alone or in combination with the first aspect, the location resolution operational state includes at least one of a first location resolution operational state associated with the UE not supporting GNSS-based operation, a second location resolution operational state associated with the UE supporting GNSS-based operation and not having an active connection with a GNSS, or a third location resolution operational state associated with the UE having the active connection with the GNSS.

In a third aspect, alone or in combination with one or more of the first and second aspects, the configuration information includes a random access configuration that is associated with the location resolution operational state.

In a fourth aspect, alone or in combination with one or more of the first through third aspects, the random access configuration is configured to enable the UE to perform a random access operation with the second network node without an active connection with a GNSS.

In a fifth aspect, alone or in combination with one or more of the first through fourth aspects, the location resolution operational state is a first location resolution operational state, the random access configuration includes a first random access configuration that is configured for the first location resolution operational state and a second random access configuration that is configured for a second location resolution operational state, and the second location resolution operational state is associated with the UE having an active connection with a GNSS.

In a sixth aspect, alone or in combination with one or more of the first through fifth aspects, the random access configuration indicates a set of random access resources, and the random access configuration indicates that the UE is configured to use a subset of random access resources from the set of random access resources, where the subset of random access resources is configured for the location resolution operational state.

In a seventh aspect, alone or in combination with one or more of the first through sixth aspects, the configuration information indicates that the UE is configured to perform time-frequency pre-compensation during a random access operation with the second network node, where the message is associated with the random access operation.

In an eighth aspect, alone or in combination with one or more of the first through seventh aspects, the configuration information indicates at least one of a timing adjustment value or a frequency adjustment value for a random access operation between the UE and the second network node, and transmitting the message includes transmitting the message using the timing adjustment value or the frequency adjustment value.

In a ninth aspect, alone or in combination with one or more of the first through eighth aspects, the configuration information indicates a command to clear an accumulated timing adjustment value or an accumulated frequency adjustment value, and transmitting the message includes transmitting the message after clearing the accumulated timing adjustment value or the accumulated frequency adjustment value.

In a tenth aspect, alone or in combination with one or more of the first through ninth aspects, the configuration information indicates a correction value that is configured for timing adjustment or frequency adjustment, and transmitting the message includes transmitting the message using timing information that is based on the correction value or frequency information that is based on the correction value.

In an eleventh aspect, alone or in combination with one or more of the first through tenth aspects, the location resolution operational state is a first location resolution operational state, the configuration information includes a first random access configuration for a second location resolution operational state and does not include a second random access configuration for the first location resolution operational state, and transmitting the message includes transmitting, in the second location resolution operational state, the message in accordance with the first random access configuration.

In a twelfth aspect, alone or in combination with one or more of the first through eleventh aspects, process 800 includes switching from the first location resolution operational state to the second location resolution operational state based on the configuration information not including the second random access configuration for the first location resolution operational state.

In a thirteenth aspect, alone or in combination with one or more of the first through twelfth aspects, the first location resolution operational state is associated with the UE supporting GNSS-based operation and the UE not having an active connection with a GNSS, and the second location resolution operational state is associated with the UE having the active connection with the GNSS.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIG. 5. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a first network node, configuration information that is configured to enable the UE to establish a connection with a second network node, wherein the UE is configured to operate in a location resolution operational state, and wherein the configuration information is associated with the location resolution operational state. The transmission component 904 may transmit, to the second network node, a message for establishing the connection to an NTN cell supported by the second network node, in accordance with the configuration information.

The communication manager 906 may switch from the first location resolution operational state to the second location resolution operational state based on the configuration information not including the second random access configuration for the first location resolution operational state.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a second network node, a handover request message indicating a handover request for a UE, wherein the second network node is configured to operate an NTN cell, and wherein the handover request message includes first information indicative of a location resolution operational state of the UE. The reception component 1002 may receive, from the second network node, a handover acknowledgment message that includes second information indicating whether the handover request is accepted, wherein the second information is associated with the location resolution operational state. The transmission component 1004 may transmit, to the UE, the configuration information.

The reception component 1002 may receive, from a second network node, a handover request message indicating a handover request for a UE, wherein the apparatus 1000 is configured to support an NTN cell, and wherein the handover request message includes first information indicative of a location resolution operational state of the UE. The transmission component 1004 may transmit, to the second network node, a handover acknowledgment message that includes second information indicating whether the handover request is accepted, wherein the second information is associated with the location resolution operational state.

The reception component 1002 may receive, from the UE, a random access message in accordance with the configuration information.

The reception component 1002 may receive, from the UE, a message associated with the random access operation, wherein the message uses at least one of timing information that is based on the timing adjustment value, or frequency information that is based on the frequency adjustment value.

The reception component 1002 may receive, from the UE, a message using timing information that is based on the correction value or frequency information that is based on the correction value. The communication manager 1006 may perform a handover operation with the UE in accordance with the location resolution operational state of the UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 1

The following provides an overview of some Aspects of the present disclosure:

Aspect 1: A method of wireless communication performed by a first network node, comprising: transmitting, to a second network node, a handover request message indicating a handover request for a user equipment (UE), wherein the second network node is configured to support a non-terrestrial network (NTN) cell, and wherein the handover request message includes first information indicative of a location resolution operational state of the UE; and receiving, from the second network node, a handover acknowledgment message that includes second information indicating whether the handover request is accepted, wherein the second information is associated with the location resolution operational state.

Aspect 2: The method of Aspect 1, wherein the location resolution operational state includes at least one of: a first location resolution operational state associated with the UE not supporting global navigation satellite system (GNSS)-based operation, a second location resolution operational state associated with the UE supporting GNSS-based operation and not having an active connection with a GNSS, or a third location resolution operational state associated with the UE having the active connection with the GNSS.

Aspect 3: The method of any of Aspects 1-2, wherein the location resolution operational state indicates that the UE does not have an active connection with a global navigation satellite system (GNSS), wherein the second information indicates that the handover request is accepted, wherein the second information includes configuration information that is configured to enable the UE to establish a connection with the second network node, and wherein the configuration information is based on the location resolution operational state.

Aspect 4: The method of Aspect 3, further comprising: transmitting, to the UE, the configuration information.

Aspect 5: The method of any of Aspects 3-4, wherein the configuration information includes a random access configuration that is associated with the location resolution operational state.

Aspect 6: The method of Aspect 5, wherein the random access configuration is configured to enable the UE to perform a random access operation with the second network node without the active connection with the GNSS.

Aspect 7: The method of any of Aspects 5-6, wherein the location resolution operational state is a first location resolution operational state, wherein the random access configuration includes a first random access configuration that is configured for the first location resolution operational state and a second random access configuration that is configured for a second location resolution operational state, and wherein the second location resolution operational state is associated with the UE having the active connection with the GNSS.

Aspect 8: The method of any of Aspects 5-7, wherein the random access configuration indicates a set of random access resources, and wherein the random access configuration indicates that the UE is configured to use a subset of random access resources from the set of random access resources, wherein the subset of random access resources is configured for the location resolution operational state.

Aspect 9: The method of any of Aspects 3-8, wherein the configuration information indicates that the UE is configured to perform time-frequency pre-compensation during a random access operation in the location resolution operational state.

Aspect 10: The method of any of Aspects 3-9, wherein the configuration information indicates at least one of a timing adjustment value or a frequency adjustment value for a random access operation between the UE and the second network node.

Aspect 11: The method of any of Aspects 3-10, wherein the configuration information indicates a command to clear accumulated timing adjustment values or frequency adjustment values.

Aspect 12: The method of any of Aspects 3-11, wherein the configuration information indicates a correction value that is configured for timing adjustment determination or frequency adjustment determination.

Aspect 13: The method of any of Aspects 1-12, wherein the first information includes assistance information associated with time-frequency pre-compensation for the UE.

Aspect 14: The method of Aspect 13, wherein the assistance information indicates at least one of accumulated timing adjustment information or frequency adjustment information for the UE.

Aspect 15: The method of any of Aspects 13-14, wherein the assistance information includes an estimated location of the UE.

Aspect 16: The method of any of Aspects 1-15, wherein the second information indicates that the handover request is rejected, and wherein the second information includes a cause indication that is indicative of the second network node not supporting handover associated with the location resolution operational state of the UE.

Aspect 17: The method of any of Aspects 1-16, wherein the second information indicates that the handover request is accepted, and wherein the second information indicates that the second network node supports handover associated with the location resolution operational state of the UE.

Aspect 18: A method of wireless communication performed by a first network node, comprising: receiving, from a second network node, a handover request message indicating a handover request for a user equipment (UE), wherein the first network node is configured to support a non-terrestrial network (NTN) cell, and wherein the handover request message includes first information indicative of a location resolution operational state of the UE; and transmitting, to the second network node, a handover acknowledgment message that includes second information indicating whether the handover request is accepted, wherein the second information is associated with the location resolution operational state.

Aspect 19: The method of Aspect 18, wherein the location resolution operational state includes at least one of: a first location resolution operational state associated with the UE not supporting GNSS-based operation, a second location resolution operational state associated with the UE supporting GNSS-based operation and not having an active connection with a GNSS, or a third location resolution operational state associated with the UE having the active connection with the GNSS.

Aspect 20: The method of any of Aspects 18-19, wherein the location resolution operational state indicates that the UE does not have an active connection with a GNSS, wherein the second information indicates that the handover request is accepted, wherein the second information includes configuration information that is configured to enable the UE to establish a connection with the first network node, and wherein the configuration information is based on the location resolution operational state.

Aspect 21: The method of Aspect 20, further comprising: receiving, from the UE, a random access message in accordance with the configuration information.

Aspect 22: The method of any of Aspects 20-21, wherein the configuration information includes a random access configuration that is associated with the location resolution operational state.

Aspect 23: The method of Aspect 22, wherein the random access configuration is configured to enable the UE to perform a random access operation with the first network node without the active connection with the GNSS.

Aspect 24: The method of any of Aspects 22-23, wherein the location resolution operational state is a first location resolution operational state, wherein the random access configuration includes a first random access configuration that is configured for the first location resolution operational state and a second random access configuration that is configured for a second location resolution operational state, and wherein the second location resolution operational state is associated with the UE having the active connection with the GNSS.

Aspect 25: The method of any of Aspects 22-24, wherein the random access configuration indicates a set of random access resources, and wherein the random access configuration indicates that the UE is configured to use a subset of random access resources from the set of random access resources, wherein the subset of random access resources is configured for the location resolution operational state.

Aspect 26: The method of any of Aspects 20-25, wherein the configuration information indicates that the UE is configured to perform time-frequency pre-compensation during a random access operation with the first network node in the location resolution operational state.

Aspect 27: The method of any of Aspects 20-26, wherein the configuration information indicates at least one of a timing adjustment value or a frequency adjustment value for a random access operation between the UE and the first network node.

Aspect 28: The method of Aspect 27, further comprising: receiving, from the UE, a message associated with the random access operation, wherein the message uses at least one of: timing information that is based on the timing adjustment value, or frequency information that is based on the frequency adjustment value.

Aspect 29: The method of any of Aspects 20-28, wherein the configuration information indicates a command to clear accumulated timing adjustment values or frequency adjustment values.

Aspect 30: The method of any of Aspects 20-29, wherein the configuration information indicates a correction value that is configured for timing adjustment determination or frequency adjustment determination.

Aspect 31: The method of Aspect 30, further comprising: receiving, from the UE, a message using timing information that is based on the correction value or frequency information that is based on the correction value.

Aspect 32: The method of any of Aspects 18-31, wherein the first information includes assistance information associated with time-frequency pre-compensation for the UE.

Aspect 33: The method of Aspect 32, wherein the assistance information indicates at least one of accumulated timing adjustment information or frequency adjustment information for the UE.

Aspect 34: The method of any of Aspects 32-33, wherein the assistance information includes an estimated location of the UE.

Aspect 35: The method of any of Aspects 18-34, wherein the second information indicates that the handover request is rejected, and wherein the second information includes a cause indication that is indicative of the first network node not supporting handover associated with the location resolution operational state of the UE.

Aspect 36: The method of any of Aspects 18-35, wherein the second information indicates that the handover request is accepted, and wherein the second information indicates that the first network node supports handover associated with the location resolution operational state of the UE.

Aspect 37: The method of any of Aspects 18-36, further comprising: performing a handover operation with the UE in accordance with the location resolution operational state of the UE.

Aspect 38: A method of wireless communication performed by a user equipment (UE), comprising: receiving, from a first network node, configuration information that is configured to enable the UE to establish a connection with a second network node, wherein the UE is configured to operate in a location resolution operational state, and wherein the configuration information is associated with the location resolution operational state; and transmitting, to the second network node, a message for establishing the connection to a non-terrestrial network (NTN) cell supported by the second network node, in accordance with the configuration information.

Aspect 39: The method of Aspect 38, wherein the configuration information includes a random access configuration associated with the location resolution operational state, and wherein the message includes a random access message that is in accordance with the random access configuration.

Aspect 40: The method of any of Aspects 38-39, wherein the location resolution operational state includes at least one of: a first location resolution operational state associated with the UE not supporting GNSS-based operation, a second location resolution operational state associated with the UE supporting GNSS-based operation and not having an active connection with a GNSS, or a third location resolution operational state associated with the UE having the active connection with the GNSS.

Aspect 41: The method of any of Aspects 38-40, wherein the configuration information includes a random access configuration that is associated with the location resolution operational state.

Aspect 42: The method of Aspect 41, wherein the random access configuration is configured to enable the UE to perform a random access operation with the second network node without an active connection with a GNSS.

Aspect 43: The method of any of Aspects 41-42, wherein the location resolution operational state is a first location resolution operational state, wherein the random access configuration includes a first random access configuration that is configured for the first location resolution operational state and a second random access configuration that is configured for a second location resolution operational state, and wherein the second location resolution operational state is associated with the UE having an active connection with a GNSS.

Aspect 44: The method of any of Aspects 41-43, wherein the random access configuration indicates a set of random access resources, and wherein the random access configuration indicates that the UE is configured to use a subset of random access resources from the set of random access resources, wherein the subset of random access resources is configured for the location resolution operational state.

Aspect 45: The method of any of Aspects 38-44, wherein the configuration information indicates that the UE is configured to perform time-frequency pre-compensation during a random access operation with the second network node, wherein the message is associated with the random access operation.

Aspect 46: The method of any of Aspects 38-45, wherein the configuration information indicates at least one of a timing adjustment value or a frequency adjustment value for a random access operation between the UE and the second network node, and wherein transmitting the message comprises: transmitting the message using the timing adjustment value or the frequency adjustment value.

Aspect 47: The method of any of Aspects 38-46, wherein the configuration information indicates a command to clear an accumulated timing adjustment value or an accumulated frequency adjustment value, and wherein transmitting the message comprises: transmitting the message after clearing the accumulated timing adjustment value or the accumulated frequency adjustment value.

Aspect 48: The method of any of Aspects 38-47, wherein the configuration information indicates a correction value that is configured for timing adjustment or frequency adjustment, and wherein transmitting the message comprises: transmitting the message using timing information that is based on the correction value or frequency information that is based on the correction value.

Aspect 49: The method of any of Aspects 38-48, wherein the location resolution operational state is a first location resolution operational state, wherein the configuration information includes a first random access configuration for a second location resolution operational state and does not include a second random access configuration for the first location resolution operational state, and wherein transmitting the message comprises: transmitting, in the second location resolution operational state, the message in accordance with the first random access configuration.

Aspect 50: The method of Aspect 49, further comprising: switching from the first location resolution operational state to the second location resolution operational state based on the configuration information not including the second random access configuration for the first location resolution operational state.

Aspect 51: The method of any of Aspects 49-50, wherein the first location resolution operational state is associated with the UE supporting GNSS-based operation and the UE not having an active connection with a GNSS, and wherein the second location resolution operational state is associated with the UE having the active connection with the GNSS.

Aspect 52: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.

Aspect 53: An apparatus for wireless communication at a device, the apparatus comprising one or more memories and one or more processors coupled to the one or more memories, the one or more processors configured to cause the device to perform the method of one or more of Aspects 1-51.

Aspect 54: An apparatus for wireless communication, the apparatus comprising at least one means for performing the method of one or more of Aspects 1-51.

Aspect 55: A non-transitory computer-readable medium storing code for wireless communication, the code comprising instructions executable by one or more processors to perform the method of one or more of Aspects 1-51.

Aspect 56: A non-transitory computer-readable medium storing a set of instructions for wireless communication, the set of instructions comprising one or more instructions that, when executed by one or more processors of a device, cause the device to perform the method of one or more of Aspects 1-51.

Aspect 57: A device for wireless communication, the device comprising a processing system that includes one or more processors and one or more memories coupled with the one or more processors, the processing system configured to cause the device to perform the method of one or more of Aspects 1-51.

Aspect 58: An apparatus for wireless communication at a device, the apparatus comprising one or more memories and one or more processors coupled to the one or more memories, the one or more processors individually or collectively configured to cause the device to perform the method of one or more of Aspects 1-51.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network node for wireless communication, comprising:
one or more memories; and
one or more processors, coupled to the one or more memories, configured to cause the first network node to:
transmit, to a second network node, a handover request message indicating a handover request for a user equipment (UE), wherein the second network node is configured to support a non-terrestrial network (NTN) cell, and wherein the handover request message includes first information indicative of a location resolution operational state of the UE; and
receive, from the second network node, a handover acknowledgment message that includes second information indicating whether the handover request is accepted, wherein the second information is associated with the location resolution operational state.

2. The first network node of claim 1, wherein the location resolution operational state indicates that the UE does not have an active connection with a global navigation satellite system (GNSS), wherein the second information indicates that the handover request is accepted, wherein the second information includes configuration information that is configured to enable the UE to establish a connection with the second network node, and wherein the configuration information is based on the location resolution operational state.

3. The first network node of claim 2, wherein the one or more processors are further configured to cause the first network node to:
transmit, to the UE, the configuration information.

4. The first network node of claim 2, wherein the configuration information includes a random access configuration that is associated with the location resolution operational state.

5. The first network node of claim 4, wherein the random access configuration is configured to enable the UE to perform a random access operation with the second network node without the active connection with the GNSS.

6. The first network node of claim 4, wherein the location resolution operational state is a first location resolution operational state, wherein the random access configuration includes a first random access configuration that is configured for the first location resolution operational state and a second random access configuration that is configured for a second location resolution operational state, and wherein the second location resolution operational state is associated with the UE having the active connection with the GNSS.

7. The first network node of claim 4, wherein the random access configuration indicates a set of random access resources, and wherein the random access configuration indicates that the UE is configured to use a subset of random access resources from the set of random access resources, wherein the subset of random access resources is configured for the location resolution operational state.

8. The first network node of claim 2, wherein the configuration information indicates that the UE is configured to perform time-frequency pre-compensation during a random access operation in the location resolution operational state.

9. The first network node of claim 2, wherein the configuration information indicates at least one of a timing adjustment value or a frequency adjustment value for a random access operation between the UE and the second network node.

10. The first network node of claim 2, wherein the configuration information indicates a command to clear accumulated timing adjustment values or frequency adjustment values.

11. The first network node of claim 2, wherein the configuration information indicates a correction value that is configured for timing adjustment determination or frequency adjustment determination.

12. The first network node of claim 1, wherein the first information includes assistance information associated with time-frequency pre-compensation for the UE.

13. The first network node of claim 12, wherein the assistance information indicates at least one of accumulated timing adjustment information or frequency adjustment information for the UE.

14. The first network node of claim 12, wherein the assistance information includes an estimated location of the UE.

15. The first network node of claim 1, wherein the second information indicates that the handover request is rejected, and wherein the second information includes a cause indication that is indicative of the second network node not supporting handover associated with the location resolution operational state of the UE.

16. The first network node of claim 1, wherein the second information indicates that the handover request is accepted, and wherein the second information indicates that the second network node supports handover associated with the location resolution operational state of the UE.

17. A first network node for wireless communication, comprising:
one or more memories; and
one or more processors, coupled to the one or more memories, configured to cause the first network node to:
receive, from a second network node, a handover request message indicating a handover request for a user equipment (UE), wherein the first network node is configured to support a non-terrestrial network (NTN) cell, and wherein the handover request message includes first information indicative of a location resolution operational state of the UE; and
transmit, to the second network node, a handover acknowledgment message that includes second information indicating whether the handover request is accepted, wherein the second information is associated with the location resolution operational state.

18. The first network node of claim 17, wherein the location resolution operational state indicates that the UE does not have an active connection with a global navigation satellite system (GNSS), wherein the second information indicates that the handover request is accepted, wherein the second information includes configuration information that is configured to enable the UE to establish a connection with the first network node, and wherein the configuration information is based on the location resolution operational state.

19. The first network node of claim 18, wherein the one or more processors are further configured to cause the first network node to:
receive, from the UE, a random access message in accordance with the configuration information.

20. The first network node of claim 18, wherein the configuration information includes a random access configuration that is associated with the location resolution operational state.

21. The first network node of claim 20, wherein the random access configuration is configured to enable the UE to perform a random access operation with the first network node without the active connection with the GNSS.

22. The first network node of claim 17, wherein the one or more processors are further configured to cause the first network node to:
perform a handover operation with the UE in accordance with the location resolution operational state of the UE.

23. A user equipment (UE) for wireless communication, comprising:
one or more memories; and
one or more processors, coupled to the one or more memories, configured to cause the UE to:
receive, from a first network node, configuration information that is configured to enable the UE to establish a connection with a second network node, wherein the UE is configured to operate in a location resolution operational state, and wherein the configuration information is associated with the location resolution operational state; and
transmit, to the second network node, a message for establishing the connection to a non-terrestrial network (NTN) cell supported by the second network node,
in accordance with the configuration information.

24. The UE of claim 23, wherein the configuration information indicates at least one of a timing adjustment value or a frequency adjustment value for a random access operation between the UE and the second network node, and wherein transmitting the message comprises:
transmit the message using the timing adjustment value or the frequency adjustment value.

25. The UE of claim 23, wherein the configuration information indicates a command to clear an accumulated timing adjustment value or an accumulated frequency adjustment value, and wherein transmitting the message comprises:
transmit the message after clearing the accumulated timing adjustment value or the accumulated frequency adjustment value.

26. The UE of claim 23, wherein the configuration information indicates a correction value that is configured for timing adjustment or frequency adjustment, and wherein transmitting the message comprises:
transmit the message using timing information that is based on the correction value or frequency information that is based on the correction value.

27. The UE of claim 23, wherein the location resolution operational state is a first location resolution operational state, wherein the configuration information includes a first random access configuration for a second location resolution operational state and does not include a second random access configuration for the first location resolution operational state, and wherein transmitting the message comprises:
transmit, in the second location resolution operational state, the message in accordance with the first random access configuration.

28. The UE of claim 27, wherein the one or more processors are further configured to cause the UE to: switch from the first location resolution operational state to the second location resolution operational state based on the configuration information not including the second random access configuration for the first location resolution operational state.

29. The UE of claim 27, wherein the first location resolution operational state is associated with the UE supporting global navigation satellite system (GNSS)-based operation and the UE not having an active connection with a GNSS, and wherein the second location resolution operational state is associated with the UE having the active connection with the GNSS.

30. A method of wireless communication performed by a first network node, comprising:
transmitting, to a second network node, a handover request message indicating a handover request for a user equipment (UE), wherein the second network node is configured to support a non-terrestrial network (NTN) cell, and wherein the handover request message includes first information indicative of a location resolution operational state of the UE; and
receiving, from the second network node, a handover acknowledgment message that includes second information indicating whether the handover request is accepted, wherein the second information is associated with the location resolution operational state.
